(19) United States
(12) Patent Application Publication
(10) Pub. No.: US 2026/0343707 A1
(43) Pub. Date: Oct. 29, 2026

(54) LED LAMP STRING SYSTEM AND METHOD FOR OPERATING LED LAMP STRING

(71) Applicant: SEMISILICON TECHNOLOGY CORP., New Taipei City (TW)

(72) Inventor: Wen-Chi PENG, New Taipei City (TW)

(73) Assignee: SEMISILICON TECHNOLOGY CORP., New Taipei City (TW)

(21) Appl. No.: 19/262,905

(22) Filed: Jul. 8, 2025

(30) Foreign Application Priority Data
Apr. 28, 2025 (TW) 114115993

(51) Int. Cl. H05B 45/40; H05B 47/155

(52) U.S. Cl. CPC H05B 45/40; H05B 47/155

(57) ABSTRACT

An LED lamp string system includes an LED lamp string, and the LED lamp string includes a control device and a plurality of LED lamps. Each LED lamp includes an LED apparatus, and the LED apparatus includes a sequencing circuit and a sorting circuit. When the sorting circuit of the LED apparatus compares a serial number with a sorting code and the comparison result is the same, the LED lamp generates a lighting behavior.

### CROSS-REFERENCE TO RELATED APPLICATION

This application claims benefit of priority to Taiwanese Patent Application No. 114115993 filed Apr. 28, 2025, the entire contents of which are incorporated herein by reference.

### BACKGROUND

### Technical Field

The present disclosure relates to an LED light string system, and more particularly to an LED light string system and method for setting a serial position of an LED lamp.

### Description of Related Art

The statements in this section merely provide background information related to the present disclosure and do not necessarily constitute prior art.

Since light-emitting diode (LED) has the advantages of high luminous efficiency, low power consumption, long life span, fast response, high reliability, etc., LEDs have been widely used in lighting fixtures or decorative lighting, such as Christmas tree lighting, lighting effects of sport shoes, etc. by connecting light bars or light strings in series, parallel, or series-parallel.

Take the festive light for example. Basically, a complete LED lamp includes an LED light string having a plurality of LEDs and a drive unit for driving the LEDs. The drive unit is electrically connected to the LED light string, and controls the LEDs by a pixel control manner or a synchronous manner by providing the required power and the control signal having light data to the LEDs, thereby implementing various lighting output effects and changes of the LED lamp.

According to the present technology, in order to drive the LEDs of the LED light string to diversify light emission, the LEDs have different address sorting data. The LEDs receive lighting signals including light data and address data. If the address sorting data of the LEDs are the same as the address data of the lighting signals, the LEDs emit light according to the light data of the lighting signals. If the address sorting data of the LEDs are not the same as the address data of the lighting signals, the LEDs ignore the light data of the lighting signals.

At present, most of the LED sequence methods of the LED light string are complicated and/or difficult. For example, before the LEDs are combined into an LED light string, it is necessary to burn different address sorting data for each LED. Afterward, the LEDs are sequentially arranged and combined into the LED light string according to the address sorting data. If the LEDs are not arranged in sequence according to the address sorting data, the diversified light emission of the LEDs cannot be correctly achieved.

Furthermore, the current RC sequencing method requires the use of previously known light string conditions, such as light distance, wire resistance, etc., and according to these conditions, the pulse width sent by the controller is set in advance. When the finished product is powered on, these different pulse widths are used for sequencing to acquire continuous light codes, such as 1, 2, 3, and so on. However, it still has some inconveniences, such as the need to define the pulse width for a certain product in advance, and different light strings must be redefined.

Therefore, how to design an LED light string system and a method for operating an LED lamp to solve the problems and technical bottlenecks in the existing technology has become a critical topic in this field.

### SUMMARY

In order to solve the problems above, the present disclosure provides a method of operating an LED light string, and the LED light string includes a control device for transmitting signal to an electronic device and a plurality of LED lamps electrically connected to the control device. Each LED lamp includes an LED apparatus, and the method of operating the LED light string includes steps of: (a) receiving, by the LED light string, a DC power source to activate the control device and each LED apparatus. (b) sequencing each LED apparatus according to the DC power source received at its own different serial positions in the LED light string to generate a serial number and store the serial number. (c) providing, by the control device, a plurality of sorting codes to LED apparatuses, and comparing, by each LED apparatus, its own serial number with each of the sorting codes. (d) controlling, by each LED apparatus, its own LED lamps to generate a lighting behavior when one of the LED apparatuses compares the stored serial number with one of the sorting codes and a comparison result is the same.

In order to solve the problems above, the present disclosure provides an LED light string system, the LED light string system includes an LED light string receiving a DC power source, and the LED light string includes a control device and a plurality of LED lamps. Each LED lamp includes an LED apparatus, and each LED apparatus includes a sequencing circuit. The sequencing circuit is configured to sequence each LED apparatus according to the DC power source received at its own different serial position in the LED light string to generate a serial number and store the serial number. Wherein each LED apparatus is configured to control its own LED lamps to generate a lighting behavior when one of the LED apparatuses compares the stored serial number with one of a plurality of sorting codes and a comparison result is the same.

The main purpose and effect of the present disclosure is that the present disclosure LED light string system may record the lighting position of each of the LED lamps on the captured image according to the lighting behavior generated when the LED lamps are sequenced and sorted. Therefore, the present disclosure LED light string system does not need to use the traditional complicated sequencing methods such as conventional burning or defining the pulse width, which still need to set a large number of parameters in beforehand, thereby achieving the effect of improving the convenience of sequencing.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a light-emitting diode (LED) light string system having a two-wire structure according to a first embodiment of the present disclosure.

FIG. 2 is a block circuit diagram of the LED light string system having the two-wire structure according to a second embodiment of the present disclosure.

FIG. 3 is a block circuit diagram of the LED light string system having the two-wire structure according to a third embodiment of the present disclosure.

FIG. 4 is a block circuit diagram of the LED light string system having the two-wire structure according to a fourth embodiment of the present disclosure.

FIG. 5 is a block circuit diagram of the LED light string system having the two-wire structure according to a fifth embodiment of the present disclosure.

FIG. 6 is a block circuit diagram of a sequencing circuit according to a first embodiment of the present disclosure.

FIG. 7 is a block circuit diagram of the sequencing circuit according to a second embodiment of the present disclosure.

FIG. 8 is a detailed block circuit diagram of the sequencing circuit in FIG. 6.

FIG. 9 is a block circuit diagram of an LED apparatus having a two-wire structure according to a first embodiment of the present disclosure.

FIG. 10 a schematic waveform diagram of voltage detection and time counting of the plurality of LED apparatuses according to the present disclosure.

FIG. 11 is a block circuit diagram of the LED light string system having a three-wire structure according to a first embodiment of the present disclosure.

FIG. 12 is a block circuit diagram of the LED light string system having the three-wire structure according to a second embodiment of the present disclosure.

FIG. 13 is a block circuit diagram of the LED apparatus having a three-wire structure according to a first embodiment of the present disclosure.

FIG. 14 is a block circuit diagram of the LED apparatus having the three-wire structure according to a second embodiment of the present disclosure.

FIG. 15 is a block circuit diagram of the LED apparatus having the three-wire structure according to a third embodiment of the present disclosure.

FIG. 16 is a block circuit diagram of the LED apparatus having the three-wire structure according to a fourth embodiment of the present disclosure.

FIG. 17 is a schematic diagram of operating the LED light string having a sequencing function according to a first embodiment of the present disclosure.

FIG. 18 is a schematic diagram of operating the LED light string having a sequencing function according to a second embodiment of the present disclosure.

FIG. 19 is a schematic diagram of operating the LED light string having a sequencing function according to a third embodiment of the present disclosure.

FIG. 20 is a schematic waveform diagram of a data format of a lighting signal according to the present disclosure.

FIG. 21A is a flowchart of a method of operating the LED light string having a sequencing function according to the present disclosure.

FIG. 21B is a flowchart of a method of additional operating the LED light string having a sequencing function according to the present disclosure.

FIG. 22 is a schematic diagram of a packaging structure of an LED lamp according to a first embodiment of the present disclosure.

FIG. 23 is a schematic diagram of a packaging structure of the LED lamp according to a second embodiment of the present disclosure.

FIG. 24 is a block circuit diagram of the LED apparatus having the two-wire structure according to a second embodiment of the present disclosure.

FIG. 25 is a block circuit diagram of the LED apparatus having the third-wire structure according to a fifth embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

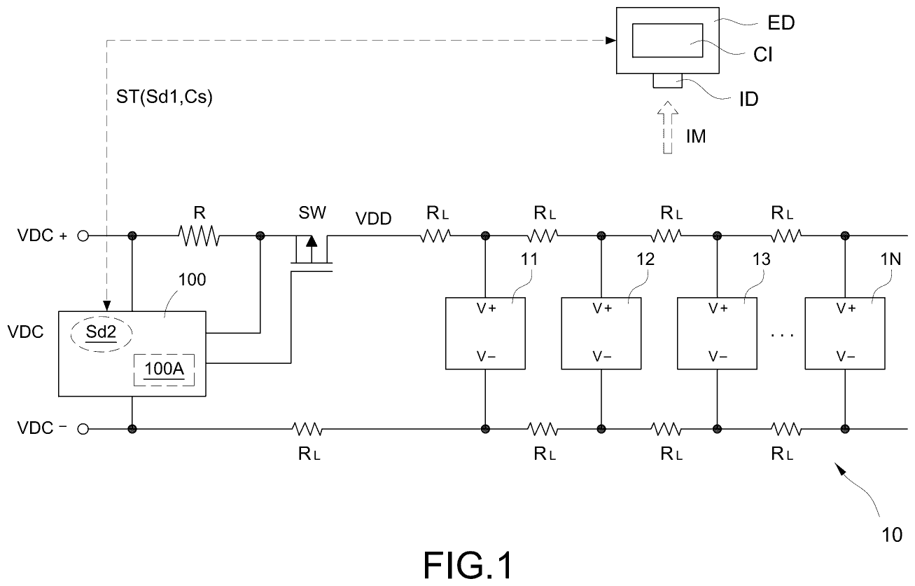

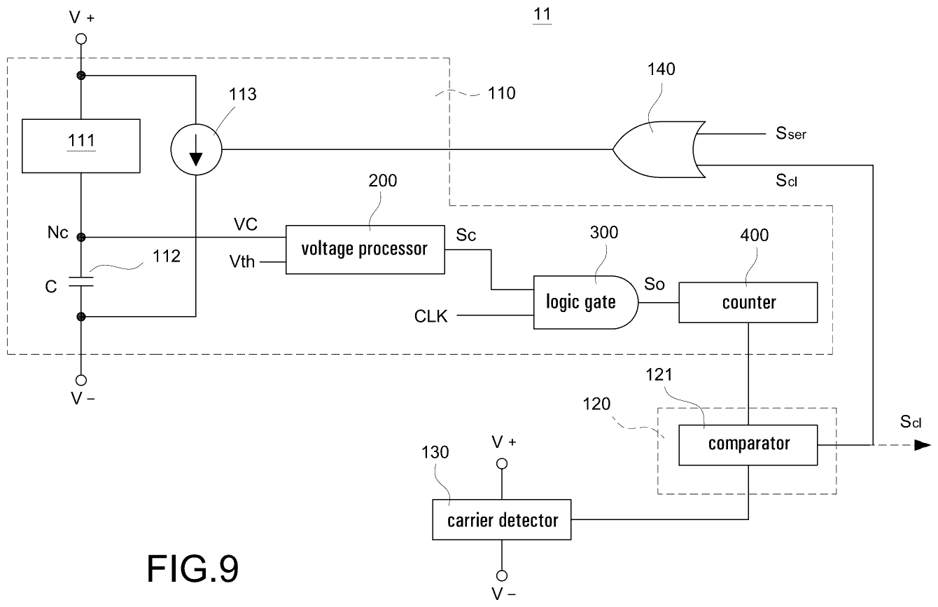

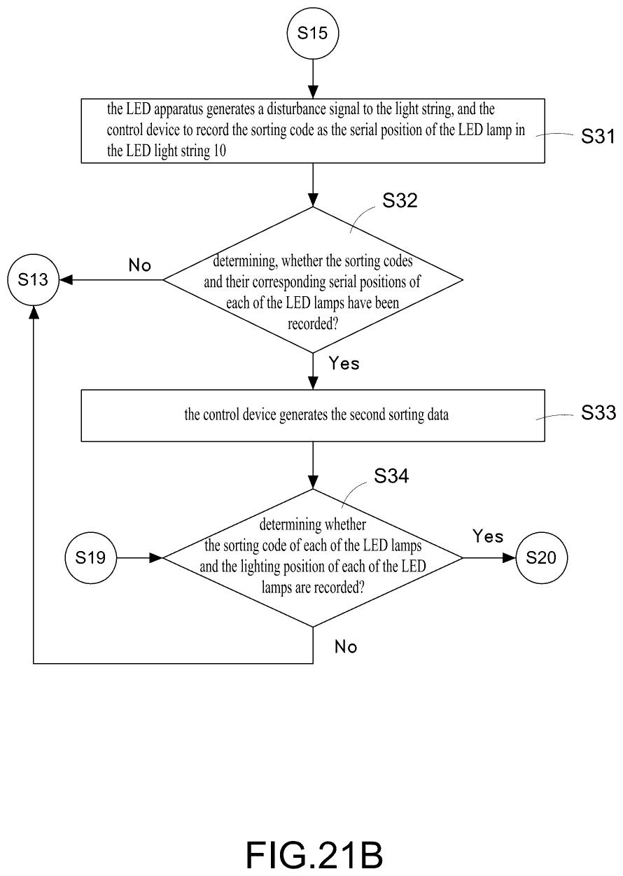

Please refer to FIG. 1 and FIG. 22, which respectively show a block circuit diagram of a light-emitting diode (LED) light string having a two-wire structure according to a first embodiment of the present disclosure and a schematic diagram of a packaging structure of an LED lamp according to a first embodiment of the present disclosure. The LED light string system SYS includes a light-emitting diode light string 10 (hereinafter referred to as the LED light string 10) and an electronic device ED, and the LED light string 10 is a two-wire structure. The so-called two-wire structure in the present disclosure means that the control and operation of the LED light string 10 are realized through two power wires. As shown in FIG. 1, the LED light string 10 receives a DC (direct-current) power source VDC, and the LED light string 10 includes a control device 100 and a plurality of LED lamps 11, 12, 13, . . . , 1N. As shown in FIG. 22, each LED lamp 11, 12, 13, . . . , 1N includes an LED apparatus 20, a plurality of LEDs 21, and a package 30. There is wire resistance RL between two LED lamps 11, 12, 13, . . . , 1N. The control device 100 is connected between a positive voltage terminal VDC+ and a negative voltage terminal VDC− of the DC power source VDC. The LED apparatus 20 of each LED lamp 11, 12, 13, . . . , 1N includes a sequencing circuit 110 and a sorting circuit 120 (see FIG. 9 for details later). When the LED light string 10 receives the DC power source VDC, the LED light string 10 enables the control device 100 with the LED apparatus 20 of each LED lamp 11, 12, 13, . . . , 1N.

The control device 100 may be connected via wired or wireless means to an electronic device ED for a signal transmission ST with the electronic device ED. The electronic device ED includes an image capture device ID and a control interface CI. The image capture device ID may be used to capture an image IM of the LED light string 10 by, for example, but not limited to, taking a photograph, taking a picture, taking an exposure, and etc. The control interface CI may be an application software, a system software application (App), and the electronic device ED may control the image capture device ID to capture the image IM of the LED light string 10 (for example, but not limited to, through the control interface CI) to record the lighting behavior of each LED lamp 11, 12, 13, . . . , 1N on the image IM. Therefore, the electronic device ED may be, for example, but not limited to, a device such as a cell phone, a computer, etc., but is not limited thereto.

Reference to FIG. 9, which show a block circuit diagram of an LED apparatus having a two-wire structure according to a first embodiment of the present disclosure, each sequencing circuit 110 performs sequencing according to the voltage values generated by the LED lamps 11, 12, 13, . . . , 1N at different serial positions of the LED light string 10 after receiving the DC power source VDC so as to generate and store serial numbers. In particular, the serial numbers are not necessarily a continuous series. For example, the serial numbers of the LED lamps 11, 12, 13, . . . , 1N are respectively #5, #9, . . . in a non-consecutive series, and the serial numbers in the non-consecutive series are gradually increasing values. Therefore, the serial numbers of the LED apparatus 20 of each LED lamp 11, 12, 13, . . . , 1N are different. The control device 100 sequentially provides a plurality of sorting codes to the LED apparatuses 20 of the LED lamps 11, 12, 13, . . . , 1N, and each sorting circuit 120 compares its own serial number with the sorting codes #1 to #N.

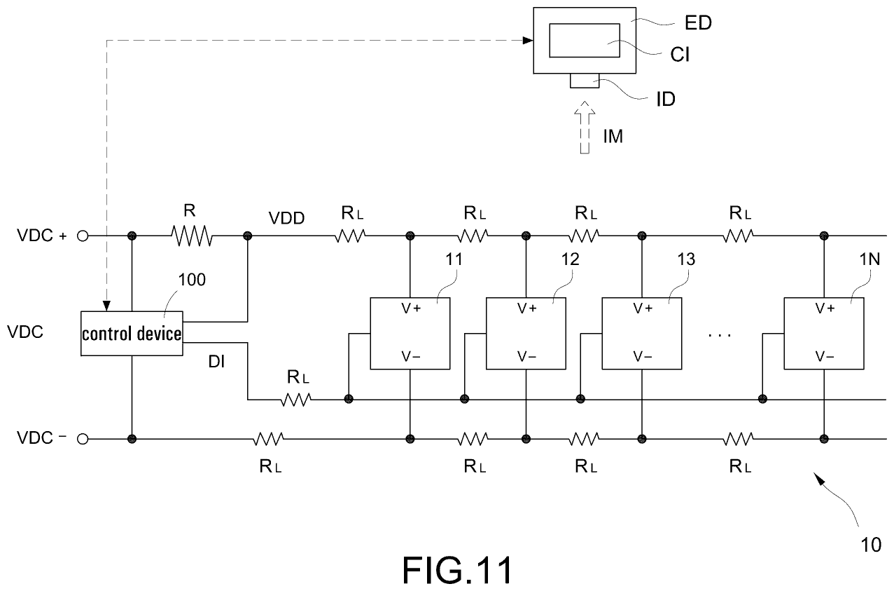

In particular, when the sorting codes #1 to #N are provided by the electronic device ED, the control interface CI of the electronic device ED may transmit (the term “send” may also be used in subsequent text) a sorting command Cs by means of a the signal transmission ST, and convert the sorting command Cs to the sorting codes #1 to #N by a signal conversion unit 100A of the control device 100 by controlling the switching of the switch unit SW of the control device 100, so as to provide the DC power source VDC with the additional sorting codes #1 to #N (i.e., the carrier signal voltage) to each of the LED lamps 11, 12, 13, . . . , 1N. Otherwise, with reference to FIG. 11, which shows a block circuit diagram of the LED light string system with a sequencing function having a three-wire structure according to a first embodiment of the present disclosure, the control device 100 may transmit to each LED lamp 11, 12, 13, . . . , 1N through a data line DI.

On the other hand, when the sorting codes #1 to #N are provided by the control device 100, the control device 100 may transmit the sorting codes #1 to #N to the control interface CI by means of the signal transmission ST, so that the control interface CI may record the sorting codes #1 to #N. Furthermore, the control device 100 may also transmit the sorting codes #1 to #N to each of the LED lamps 11, 12, 13, . . . , 1N by means of a carrier wave (carrier signal voltage) or the data line DI. In an embodiment, each LED lamp 11, 12, 13, . . . , 1N may not only receive and compare its own serial number and sorting code #1 to #N using the sorting circuit 120 including the comparator 121. That is, in addition to using the comparator 121 as the sorting circuit 120, each LED lamp 11, 12, 13, . . . , 1N may use, for example, but not limited to, logic circuits, controllers, firmware, software, and other technical means instead of the sorting circuit 120, and is not limited thereto.

For the convenience of the explanation of the present disclosure, unless otherwise specified, the following embodiments will be described by taking the LED apparatus 20 of the first LED lamp 11 as an example.

Reference to FIGS. 1, 9, 22, when the comparison result between the serial number stored in the LED apparatus 20 of the first LED lamp 11 and one of the sorting codes #1 to #N is the same, The LED apparatus 20 of the first LED lamp 11 controls the LEDs 21 of its own first LED lamp 11 to generate a lighting behavior. The lighting behavior may be a continuous lighting for a short period of time, or multiple flashes of light and dark, and is not limited herein. Thereafter, the electronic device ED may capture the image IM of the LED light string 10 by operating the image capture device ID, and the control interface CI of the electronic device ED records the sorting codes #1 to #N and a lighting position of the lighting behavior on the image IM. Since the present disclosure is explained by taking an example of the LED apparatus 20 of the first LED lamp 11, when the LEDs 21 of the first LED lamp 11 generates the lighting behavior, the image capture device ID captures the image IM of the lighting behavior of the position of the first LED lamp 11, so that the control interface CI records the sorting code #1 (assuming #1 is the first order, but not limited to this) and the lighting position on the image IM, which may correspond to the first LED lamp 11.

Continuing the above operation until the control device 100 has completed recording the sorting codes #1 to #N of each LED lamp 11, 12, 13, . . . , 1N and the lighting position of each LED lamp 11, 12, 13, . . . , 1N, the control interface CI integrates the recorded sorting codes #1 to #N and the corresponding lighting positions into a first sorting data Sd1, and provides the first sorting data Sd1 to the control device 100 by means of the signal transmission ST, so that the control device 100 acquire a first serial position of each LED lamp 11, 12, 13, . . . , 1N in the LED light string 10 by the first sorting data Sd1. Furthermore, after the control device 100 acquires each of the LED lamps 11, 12, 13, . . . , 1N, the LED light string 10 may enter a light working mode.

On the other hand, the LED light string 10 may optionally include a mechanism for double-confirmation. Further, the electronic device ED may be subject to a condition in which the serial position may be incorrectly positioned due to interference from external factors (For example, but not limited to, factors such as shaking of the image capture device ID). In order to define the serial position more accurately, a secondary confirmation may be performed with the voltage and current response of each LED lamp 11, 12, 13, . . . , 1N. Specifically, when the serial number stored in the LED apparatus 20 of the first LED lamp 11 is compared with one of the sorting codes #1 to #N and the comparison result of sorting code #1 is the same, the LED apparatus 20 may also generates a disturbance signal to the LED light string 10 to trigger the control device 100 to record the sorting code #1 as the serial position of the LED lamp 11 in the LED light string 10. In particular, the disturbance signal may be realized by a voltage disturbance signal or a current disturbance signal, and the following will take the current disturbance signal as an example. The above operation is continued until the control device 100 completes the recording of the sorting codes #1 to #N corresponding to the serial numbers of all the LED lamps 11, 12, 13, . . . , 1N, the control interface CI integrates the recorded sorting codes #1 to #N into a second sorting data Sd2, and provides the second sorting data Sd2 to the control device 100 by means of a signal transmission ST, so that the control device 100 acquire a second serial position of each LED lamp 11, 12, 13, . . . , 1N in the LED light string 10 by the second serial position. Furthermore, after the control device 100 acquires each of the LED lamps 11, 12, 13, . . . , 1N, the LED light string 10 may enter the light working mode.

On the other hand, the present disclosure does not use disturbance signals as the main means of defining the serial position, an auxiliary confirmation mechanism because the disturbance signals are only signals of small fluctuations in current and voltage. Furthermore, the serial position of each of the neighboring LED lamps 11, 12, 13, . . . , 1N differs by only one order, so the disturbance of the current and voltage of the neighboring LED lamps 11, 12, 13, . . . , 1N is even more minute, which may easily cause the control device 100 to make a false determination due to the disturbance of the current and voltage being too small (for example, but not limited to, misidentifying noise or two different LED lamps 11, 12, 13, . . . , 1N defining the same serial position, etc.), or be forced to select a control device 100 with a more accurate resolution of detection and determination, thereby increasing the cost of the circuit. Therefore, the present disclosure uses the lighting positions of the LED lamps 11, 12, 13, . . . , 1N on the image IM as the main means of defining the serial position to avoid the above-mentioned erroneous determination results, and there is no need to select the control device 100 with a more accurate resolution of detection and determination, thus achieving the effect of accurate sequencing.

The method of the control device 100 providing a plurality of sorting codes #1 to #N may be implemented in a variety of means, and both lighting behavior and disturbance signals are applicable, which is described by lighting behavior as an example. For example, the control device 100 may provide sorting codes #1 to #N in a continuous (or discontinuous) increasing sequence (e.g., #1, #2, #3, . . . ), or after detecting at least two lighting behaviors, calculate the difference value between the sorting codes #1 to #N of the LED lamps 11, 12, 13, . . . , 1N corresponding to the previous two lighting behaviors, and calculating an incremental value according to the difference value to further provide an increasing sorting code #1 to #N. Accordingly, the control device 100 may generate the next sorting code starting value after two lighting behaviors according to the incremental value, and provide the sorting code #1 to #N in increments from the sorting code starting value. This method is characterized by reducing the time required to find sorting codes #1 to #N that generate disturbance signals.

For example, the control device 100 initially provides sorting codes #1 to #N in the continuous (or discontinuous) increasing sequence (e.g., #1, #2, #3, . . . ), until #5 is provided and the first LED lamp 11 generates the lighting behavior. Next, the control device 100 continues to provide sorting codes #6 to #9 until the second LED lamp 12 generates the lighting behavior. After the control device 100 detects the second lighting behavior, the next sorting codes #1 to #N provided will generate sorting code starting value #13 according to the difference value of the first two LED lamps such as 4 as an incremental basis (the difference value from #5 to #9 is 4), and continue to send sorting codes #14, #15, #16. If the sorting code corresponding to the third LED lamp is #16 to generate the lighting behavior again, the control device 100 will use the new incremental value such as 7 as the basis (the difference value from #9 to #16 is 7) to provide the next sorting code starting value #23, and continue to send sorting codes #1 to #N with the same logic until all the LED lamp are sorted.

By the above method, the sending of redundant sorting codes #1 to #N may be effectively reduced and the sorting process may be accelerated. The incremental value set by the control device 100 is provided by dynamically generating the incremental value according to the difference value of the sorting codes #1 to #N of the neighboring LED lamps 11, 12, 13, . . . , 1N that has been completed the sorting. This not only avoids the generation of redundant sorting codes #1 to #N, but also significantly reduces the sorting time. In addition, the above method also uses the control device 100 to start sorting with the last LED lamp and provide sorting codes #1 to #N in opposite continuous (or discontinuous) decreasing sequence (e.g., #30, #29, #28, . . . ), and then similarly calculate the difference value between the sorting codes #1 to #N of the LED lamps 11, 12, 13, . . . , 1N corresponding to the previous two lighting behaviors and accordingly generates the sorting code starting value according to the calculation of the decremental value. The technical principles and incremental methods are similar to the above will not be repeated here.

On the other hand, the LED lamps 11, 12, 13, . . . , 1N of the LED light string 10 shown in FIG. 1 are connected in parallel. Moreover, the LED light string 10 further includes a switch unit SW and a resistor R, and the resistor R is connected to the switch unit SW. The switch unit SW is connected to a power supply path of the DC power source VDC, and is electrically connected to the control device 100 and the LED lamps 11, 12, 13, . . . , 1N respectively. When the LED apparatus 20 of the LED lamp 11 generates the current disturbance signal to the LED light string 10, the control device 100 is triggered to record the sorting code as the serial position of the first LED lamp 11 in the LED light string 10 according to a voltage difference of the current disturbance signal acquired by detecting a voltage across two terminals of the resistor R. In other words, when the LED apparatus 20 determines that the comparison result between the serial number and one of the sorting codes is the same, the LED apparatus 20 starts (activates) a current for a period of time. Therefore, the control device 100 can detect the change in the current through the voltage across the resistor R. In one embodiment, the starting/activating current mentioned in the present disclosure refers to the disturbance signal that forms a voltage drop across the resistor R after the LED apparatus 20 activates the load circuit or drives the LED 21 to emit light, resulting in a large current draw. After repeated several times, the control device 100 is able to acquire the serial positions of all the LED lamps 11, 12, 13, . . . , 1N, and then the sorting operation ends.

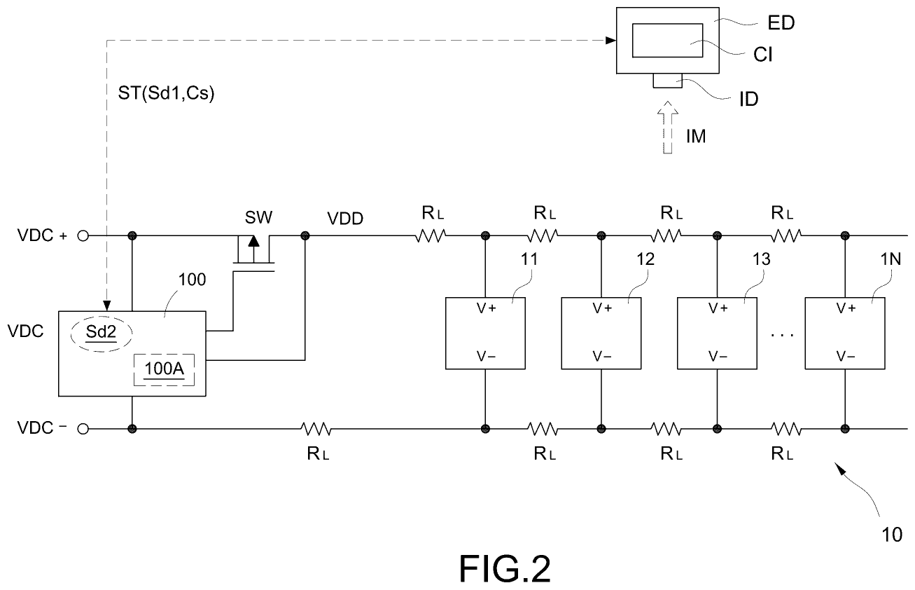

Please refer to FIG. 2, which shows a block circuit diagram of the LED light string system having the two-wire structure according to a second embodiment of the present disclosure. The method of detecting the lighting behavior in FIG. 2 is the same as that in FIG. 1, and the difference between FIG. 2 and FIG. 1 is that, the embodiment shown in FIG. 2 does not have the resistor R. Since there is no resistor R, the control device 100 instead detects a voltage across the internal resistance of the switch unit SW, such as the resistance between the drain and the source of the switch unit SW so that the current disturbance signal may also be acquired accordingly.

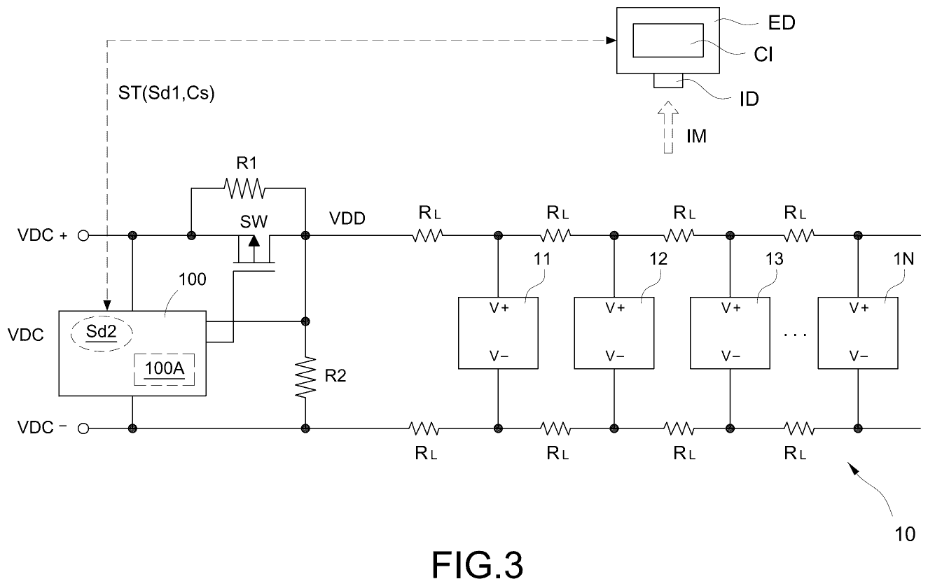

Please refer to FIG. 3, which shows a block circuit diagram of the LED light string system having the two-wire structure according to a third embodiment of the present disclosure. The method of detecting the lighting behavior in FIG. 3 is the same as that in, and the difference between FIG. 3 and FIG. 1 is that, the embodiment shown in FIG. 3 has two resistors R1, R2, and the current disturbance signal may also be acquired by detecting both terminals of the resistor R1. Incidentally, the resistor R2 may also be omitted in the embodiment shown in FIG. 3.

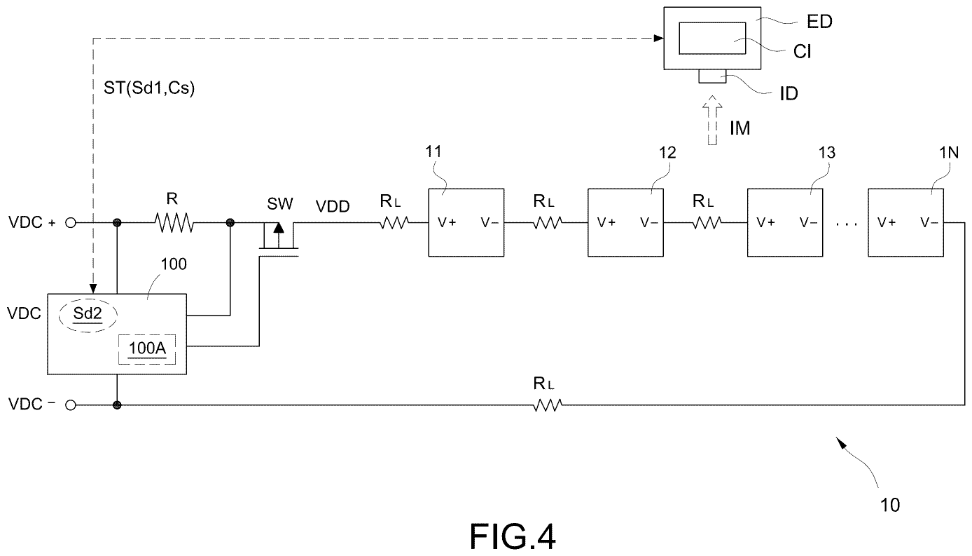

Please refer to FIG. 4, which shows a block circuit diagram of the LED light string system having the two-wire structure according to a fourth embodiment of the present disclosure. The method of detecting the lighting behavior in FIG. 4 is the same as that in, and the difference between FIG. 4 and FIG. 1 is that, the LED lamps 11, 12, 13, . . . , 1N of the LED light string 10 shown in FIG. 3 are connected in series. Similarly, the control device 100 is triggered to record the sorting codes #1 to #N as the serial positions of the LED lamps 11, 12, 13, . . . , 1N in the LED light string 10 according to the current disturbance signal generated at two terminals of the resistor R.

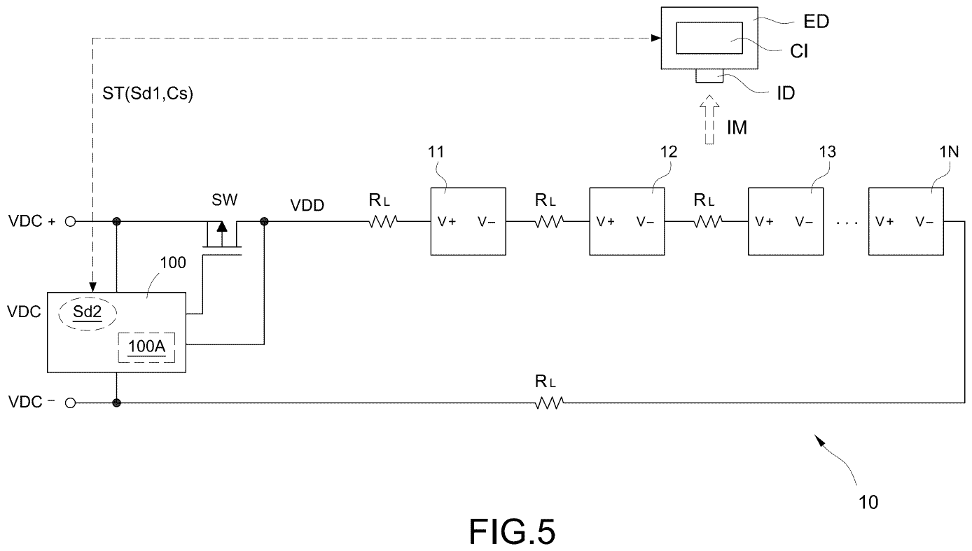

Please refer to FIG. 5, which shows a block circuit diagram of the LED light string system having the two-wire structure according to a fifth embodiment of the present disclosure. The method of detecting the lighting behavior in FIG. 5 is the same as that in, and the difference between FIG. 5 and FIG. 1 is that, the embodiment shown in FIG. 5 does not have the resistor R. Since there is no resistor R, the control device 100 instead detects a voltage across the internal resistance of the switch unit SW, such as the resistance between the drain and the source of the switch unit SW so that the current disturbance signal may also be acquired accordingly.

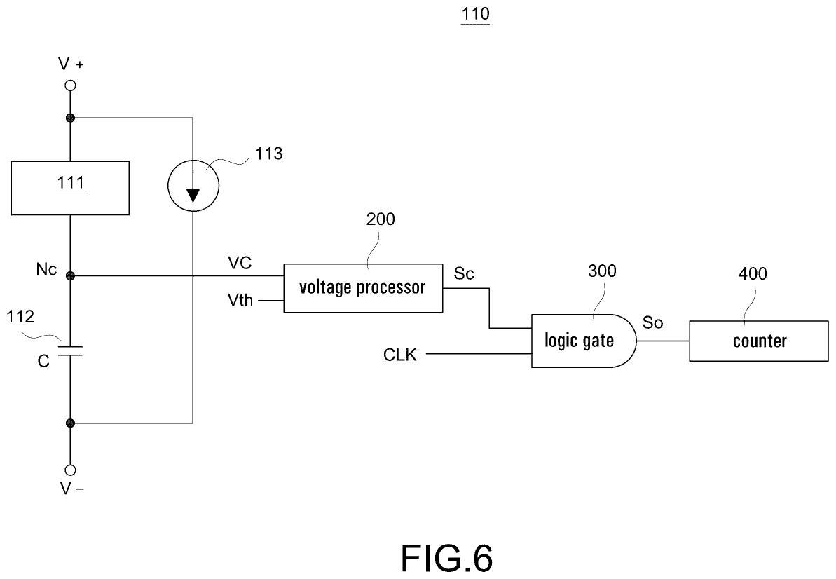

Please refer to FIG. 6, which shows a block circuit diagram of a sequencing circuit according to a first embodiment of the present disclosure. The sequencing circuit 110 shown in FIG. 6 includes a load component 111, a capacitive component 112, a current load 113, and a voltage processor 200. The load component 111 provides a resistance value. The capacitive component 112 is connected in series to the load component 111 at a node Nc, and the capacitive component 112 provides a capacitance value and generates an inner voltage VC at the node Nc. The current load 113 is connected in parallel to the load component 111 and the capacitive component 112 connected in series to provide a current path.

The voltage processor 200 receives the inner voltage VC and a threshold voltage Vth, and compares the inner voltage VC with the threshold voltage Vth to generate a comparison signal Sc. In particular, the sequencing circuit 110 counts time to acquire a time value from a starting time when the voltage processor 200 starts to generate the comparison signal Sc to a time when a level of the comparison signal Sc changes, and generates the serial number of the corresponding LED apparatus 20 according to the time value, and more details later.

As shown in FIG. 6, the sequencing circuit 110 further includes a logic gate 300 and a counter 400. The logic gate 300 receive the comparison signal Sc and a clock signal CLK, and performs the logic union operation on the comparison signal Sc and the clock signal CLK to generate an output signal So. The counter 400 receives the output signal So. In one embodiment, the logic gate 300 is an AND gate. The LED lamps 11, 12, 13, . . . , 1N receive the DC power source VDC and are supplied power by the DC power source VDC. When the inner voltage VC has not reached the threshold voltage Vth, the comparison signal Sc causes the output signal So to be the clock signal CLK and the counter 400 counts time. Until the inner voltage VC reaches the threshold voltage Vth, the comparison signal Sc causes the output signal So to stop the counter 400 from counting the clock signal CLK so as to acquire the time value during the counter counting time.

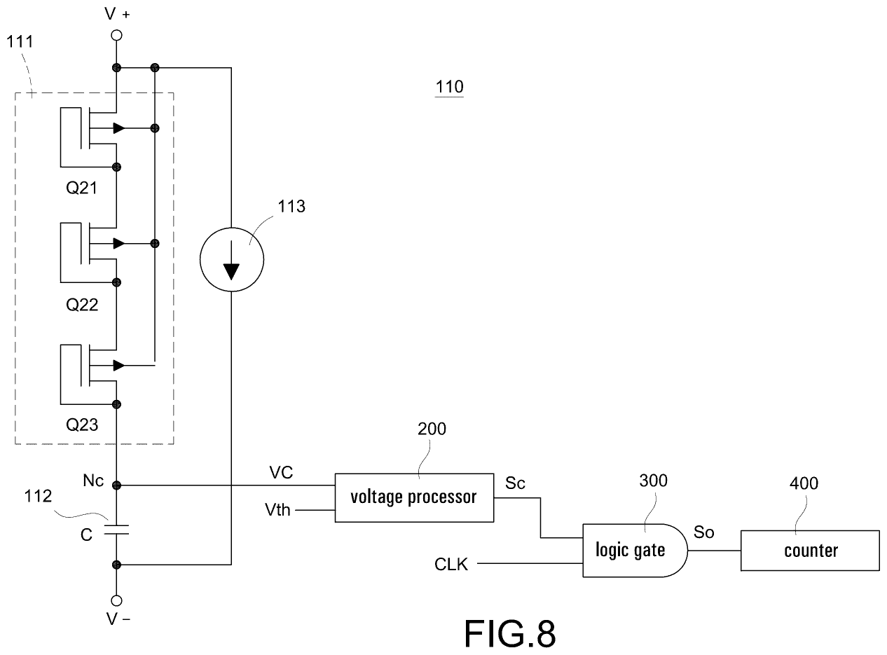

Please refer to FIG. 8, which shows a detailed block circuit diagram of the sequencing circuit in FIG. 6. In this embodiment, the load component 111 includes a plurality of transistor switches Q21, Q22, Q23 (for example, but not limited to, P-type MOSFET switches) connected in series, and the capacitive component 112 is a capacitor C. The self-impedance values of the series-connected transistor switches Q21, Q22, Q23 form an equivalent impedance value. In particular, the equivalent impedance value and a capacitance value of the capacitor C are used to determine the time for charging the capacitive component 112 to the inner voltage VC. The smaller a time constant (the product of the impedance value and the capacitance value), the faster the capacitive component 112 is charged; on the contrary, the larger the time constant, the slower the capacitive component 112 is charged. However, the load component 111 of the present disclosure is not limited to the plurality of transistor switches Q21, Q22, Q23 connected in series, that is, it may also be composed of a single resistor, or a plurality of diodes and a transistor switch connected in series.

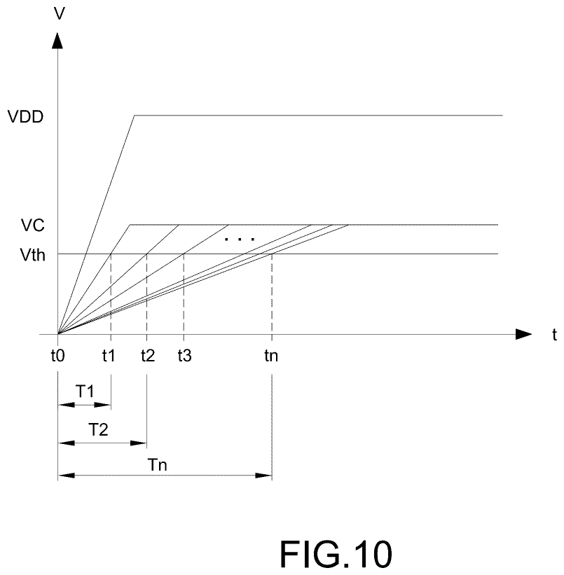

Please refer to FIG. 10, which shows a schematic waveform diagram of voltage detection and time counting of the plurality of LED apparatuses according to the present disclosure. The plurality of transition times t1, t2, . . . , tn when the inner voltages VC of the plurality of LED apparatuses 20 of the LED lamps 11, 12, 13, . . . , 1N respectively reach the threshold voltage Vth, i.e., the transition from the high level to the low level at the transition times respectively are produced. Therefore, the serial numbers of the corresponding LED lamps 11, 12, 13, . . . , 1N are determined according to a plurality of time differences T1, T2, . . . , Tn from the starting time t0 to the plurality of transition times t1, t2, . . . , tn respectively.

Specifically, taking the first LED lamp 11 as an example, when the inner voltage VC has not reached the threshold voltage Vth, the comparison signal Sc is high level, and therefore the comparison signal Sc causes the output signal So to be the clock signal CLK and the counter 400 counts time. In one embodiment, the counter 400 counts time once in each clock cycle, and therefore the number of times of the clock signal CLK is accumulated during the counter 400 counting time when the inner voltage VC has not reached the threshold voltage Vth. Until the inner voltage VC reaches the threshold voltage Vth, the comparison signal Sc is changed to low level to cause the output signal So to stop the counter 400 from counting the clock signal CLK so as acquire an accumulated number, and the accumulated number can be correspondingly converted into a time value. As shown in FIG. 10, the plurality of accumulated times acquired by the LED lamps 11, 12, 13, . . . , 1N of the LED apparatus 20 are the corresponding plurality of transition times transition times t1, t2, . . . , tn. In other words, the first transition time t1 is corresponding to the accumulated number acquired by the first LED lamp 11 or the time value from the starting time to the time of transition related to the first LED lamp 11. Similarly, the second transition time t2 is corresponding to the accumulated number acquired by the second LED lamp 12 or the time value from the starting time to the time of transition related to the second LED lamp 12. So on and so forth, the Nth transition time tn is corresponding to the accumulated number acquired by the Nth LED lamp 1N or the time value from the starting time to the time of transition related to the Nth LED lamp 1N.

For example, the LED apparatus 20 internally generates a clock frequency of a specific frequency as the clock signal CLK as an example for illustration. When the control device 100 turns on the switch unit SW and the LED lamps 11, 12, 13, . . . , 1N are powered on at the staring time, i.e., the starting time t0 shown in FIG. 10, the LED apparatus 20 internally generates the clock frequency of the specific frequency as the clock signal CLK. For the first LED lamp 11, the voltage VDD charges the capacitive component 112 so that the inner voltage VC at the node Nc gradually changes. After the voltage processor 200 compares the inner voltage VC with the threshold voltage Vth, the comparison signal Sc outputted from the voltage processor 200 is in a high level if the inner voltage VC is less than the threshold voltage Vth. In this condition, the comparison signal Sc causes the output signal So outputted from the logic gate 300 to be the clock signal CLK, and therefore the counter 400 counts time once in each clock cycle to accumulate the number of times of the clock signal CLK. Until the time t1 (i.e., the first transition time), the inner voltage VC reaches the threshold voltage Vth, and the comparison signal Sc outputted from the voltage processor 200 is changed to low level. When the logic gate 300 receives the comparison signal Sc with the low level, the output signal So stops the counter 400 from counting the clock signal CLK so as acquire a first accumulated number, for example 100 times. In other words, the first accumulated number is corresponding to the first transition time. In particular, the time value from the starting time t0 to the first transition time t1 is the first time difference T1.

Similarly, for the second LED lamp 12, its operation is similar to the first LED lamp 11. The difference is that the time it takes for the inner voltage VC on the node Nc to gradually change to the threshold voltage Vth, that is, a second transition time t2 is longer than the first transition time t1, and correspondingly a second transition time t2 is acquired, and therefore a second accumulated number is greater than the first accumulated number, for example 150 times.

Therefore, so on and so forth, for the Nth LED lamp 1N, its operation is similar to the first LED lamp 11 and the second LED lamp 12. The difference is that the time it takes for the inner voltage VC on the node Nc to gradually change to the threshold voltage Vth, that is, a Nth transition time tn is longer than the second transition time t2, and correspondingly a Nth transition time tn is acquired, and therefore a Nth accumulated number is greater than the second accumulated number, for example 800 times. Therefore, the sequence of the plurality of LED circuits 10-1 to 10-N are determined based on the plurality of time differences T1, T2, . . . , Tn from the starting time t0 to the transition times t1, t2, . . . , tn. That is, the smaller the time difference T1, T2, . . . , Tn, the sequence (serial number) of the LED lamps 11, 12, 13, . . . , 1N is earlier, and the larger the time difference T1, T2, . . . , Tn, the sequence (serial number) of the LED light string is later.

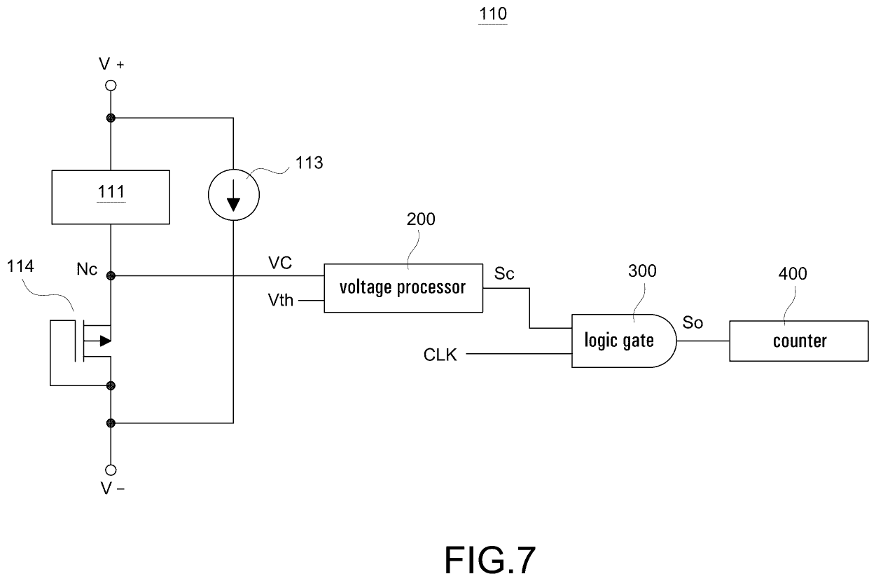

Please refer to FIG. 7, which shows a block circuit diagram of the sequencing circuit according to a second embodiment of the present disclosure. Compared with FIG. 6, in the embodiment shown in FIG. 7, a switch component 114 may be used to replace the capacitive component 112, and the sequencing operation can also be realized, so no further details are given here.

Please refer to FIG. 9, which shows a block circuit diagram of an LED apparatus having a two-wire structure according to a first embodiment of the present disclosure. As shown in FIG. 9, the LED apparatus 20 of the first LED lamp 11 includes a sequencing circuit 110 and a sorting circuit 120. The operation of the sequencing circuit 110 is the same as that described in FIG. 6 to FIG. 8, and will not be described again. The sorting circuit 120 includes a comparator 121. The comparator 121 is used to receive the sorting codes #1 to #N provided by the control device 100 and the serial number provided by the sequencing circuit 110, and compare whether the serial number is the same as one of the sorting codes #1 to #N, so that the LED apparatus 20 of each LED lamp 11, 12, 13, . . . , 1N determines according to the comparison result whether to control its own LED lamps 11, 12, 13, . . . , 1N to generate the lighting behavior. Sorting codes #1 to #N may be provided by the control interface CI to the control device 100 by means of the signal transmission ST as previously described, or provided by the control device 100 to the control interface CI with the LED apparatus 20 of each of the LED lamps 11, 12, 13, . . . , 1N.

When the comparison result of the serial number and one of the sorting codes #1 to #N is the same, the LED apparatus 20 controls its own first LED lamp 11 to generate the lighting behavior, so that the control interface CI may acquire and record the corresponding lighting position on the sorting code #1 and the image IM captured by the image capture device ID. Furthermore, until the sorting codes #1 to #N of each of the LED lamps 11, 12, 13, . . . , 1N and the lighting positions of each of the LED lamps 11, 12, 13, . . . , 1N have been recorded, the control interface CI provides the first sorting data Sd1 to the control device 100, so that the control device 100 acquires the serial positions of each of the LED lamps 11, 12, 13, . . . , 1N in the LED light string 10 through the first sorting data Sd1, and continues to perform subsequent operations. As mentioned above, the LED light string 10 may optionally include the mechanism for double-confirmation. Therefore, when the comparison result of the serial number and one of the sorting codes #1 to #N is the same, the LED apparatus 20 generates a current disturbance signal to the LED light string 10 to trigger the control device 100 to record the sorting code #1 as the serial position of the first LED lamp 11 in the LED light string 10, and cause the control device 100 to generate the second sorting data Sd2 accordingly. Then, the control device 100 may continue to perform subsequent operations after confirming that the first serial position matches the second serial position.

Moreover, the LED apparatus 20 further includes a carrier detector 130. The carrier detector 130 receive a voltage VDD provided by the DC power source VDC, and when the voltage VDD is detected that the voltage VDD is the DC power source VDC (carrier signal voltage) for the additional sorting codes #1 to #N, the sorting circuit 120 is activated to operate.

Again, using first LED lamp 11 as an example, when the LED apparatus 20 of the first LED lamp 11 determines that the comparison result of its own serial number the sorting code #1 is the same, the LED apparatus 20 provides the control signal Scl for the first LED lamp 11 to control its own LED 21 to generate a lighting behavior. Furthermore, the LED apparatus 20 may optionally include a current load controller 140 to optionally include the mechanism for double-confirmation. When entering sequencing, the control device 100 sends a sequencing signal Sser to the current load controller 140, and then the current load controller 140 activates the current load 113 to provide a current to charge the capacitive component 112 for sequencing. After the sequencing is completed within a predetermined time, the control device 100 stops sending the sequencing signal Sser so that the current load controller 140 disables the current load 113 to avoid wasting power. The comparator 121 is electrically connected to the carrier detector 130, and the comparator 121 receives the sorting codes and the serial number provided by the sequencing circuit 110, and compare whether the serial number is the same as the sorting code #1, so that the LED apparatus 20 of each of the LED lamps 11, 12, 13, . . . , 1N determines whether to generate the disturbance signal to the LED light string 10according to the comparison result. When entering sorting, and the serial number is the same as the sorting code #1, the LED apparatus 20 sends the control signal Scl to the current load controller 140. When receiving the control signal Scl, the current load controller 140 activates the current load 113 to perform current drawn so as to generate the current disturbance signal to the LED light string 10 for a period of time.

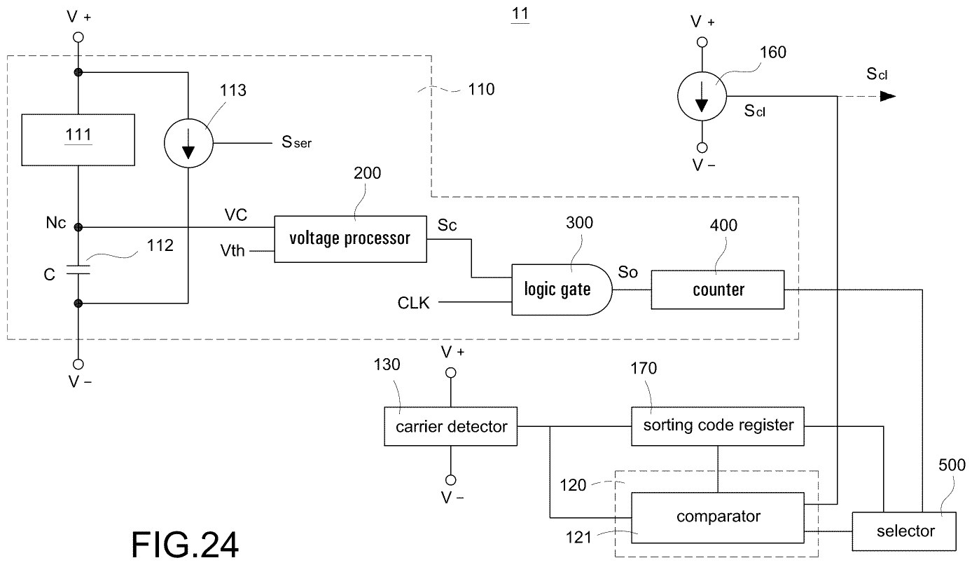

Under the condition of including the mechanism for double-confirmation, in order to enhance the effect of the current disturbance signal, the LED apparatus 20 further includes a current source 160 (see FIG. 24, which shows a block circuit diagram of the LED apparatus having the two-wire structure according to a second embodiment of the present disclosure). When comparing that the serial number is the same one of the sorting codes #1 to #N, the comparator 121 simultaneously sends the control signal Scl to activate the current source 160 so as to provide a larger current drawn to generate a larger current disturbance signal. Specifically, the current load 113 and the current source 160 are a load circuit with switch control. When the control signal Scl is received and turned on, the LED apparatus 20 may be made to draw current. Depending on different implementations, only a single current load 113 with a current draw of about 80 mA to 100 mA is used. If it is necessary to further match with the current source 160, the current draw of the current load 113 is about 10 mA, and the current draw of the current source 160 is about 80 mA to 100 mA, thereby enhancing the effect of the current disturbance signal.

Furthermore, since the counter 400 of each LED lamp is affected by the line impedance and charging time when counting the initial serial number, the initial serial number may be different. In order to ensure that each counter 400 can successfully complete the sequencing operation, the data size of the initial sequence number will be designed to be a larger bit number, such as 20 bits. However, if the 20-bit initial serial number is directly used as the serial number of the light-emitting operation, not only the response speed of the entire LED light string 10 will be slowed, but it may also cause the design size of the LED apparatus 20 to increase, thereby increasing the costs. In order to overcome the above disadvantages, the original 20-bit serial number data may be replaced by a new set of smaller bytes, such as 8-bit serial number data. This approach can effectively improve system performance and reduce design and manufacturing costs, and the detailed technical content will be further explained later.

Referring again to FIG. 24, the LED apparatus 20 of each LED lamp 11, 12, 13, . . . , 1N further includes a selector 500 and a sorting code register 170. The selector 500 is electrically connected to the comparator 121, the sorting code register 170, and the counter 400. The sorting code register 170 is electrically connected to the carrier detector 130. The selector 500 receives the serial number counted by the counter 400 and provides it to the comparator 121 for comparison with external data to complete the sorting mode. The following will describe in detail different methods of replacing the serial number data with a smaller bit size.

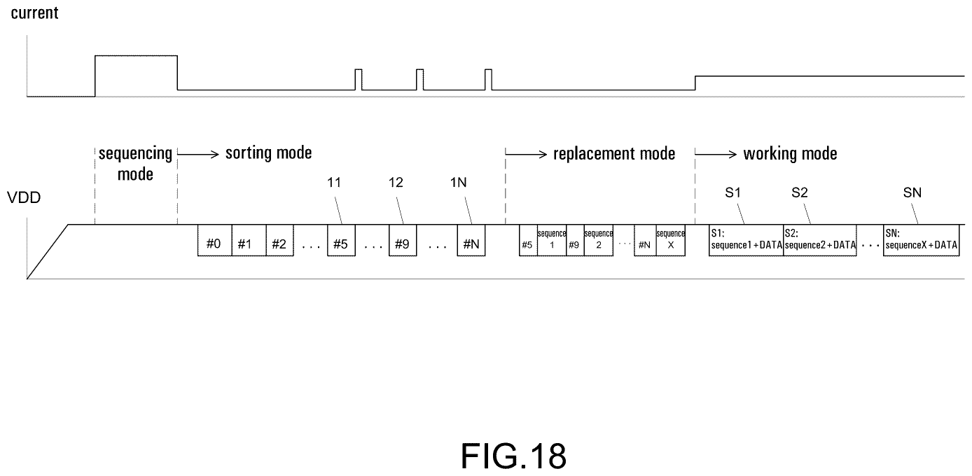

The first method, and refer to FIG. 18, after the control device 100 completes recording the serial position of each LED lamp 11, 12, 13, . . . , 1N, it will enter a replacement mode to sequentially send a plurality of replacement signals having the original sorting codes #1 to #N and for example, but not limited to, the sequence sorting codes of 8-bit data size (sequence 1 to X, corresponding to the serial numbers stored in the LED apparatus 20 of each of the LED lamps 11, 12, 13, . . . , 1N) to each LED lamp 11, 12, 13, . . . , 1N. At the same time, the original sorting codes #1 to #N are replaced by new sequence sorting codes (sequence 1 to X) as the serial positions of the LED lamp 11, 12, 13, . . . , 1N in the LED light string 10. Specifically, when the sorting of the LED lamps 11, 12, 13, . . . , 1N is complete, the lighting behaviors are generated. The counting unit (not shown) inside the control interface CI counts and records the number of times the LED light string 10 generates lighting behavior through the image IM, the control device 100 may acquire the number of times recorded by the control interface CI through signal transmission ST, and correspondingly send the plurality of replacement signals having the original sorting codes #1 to #N and the sequence sorting codes (sequence 1 to X) to each LED lamp 11, 12, 13, . . . , 1N. Taking the first LED lamp 11 as an example, the LED apparatus 20 of the first LED lamp 11 and the sorting code register 170 receive the replacement signal with the original sorting codes #5 and the sequence sorting code as sequence 1. Afterward, the comparator 121 compares the original sorting code #5 provided by the selector 500 and the sequence sorting code (sequence 1) and confirms that they are the same, the comparator 121 controls the sorting code register 170 to store an 8-bit new sequence sorting code (sequence 1), thereby replacing the original sorting code #5 of 20-bit data size.

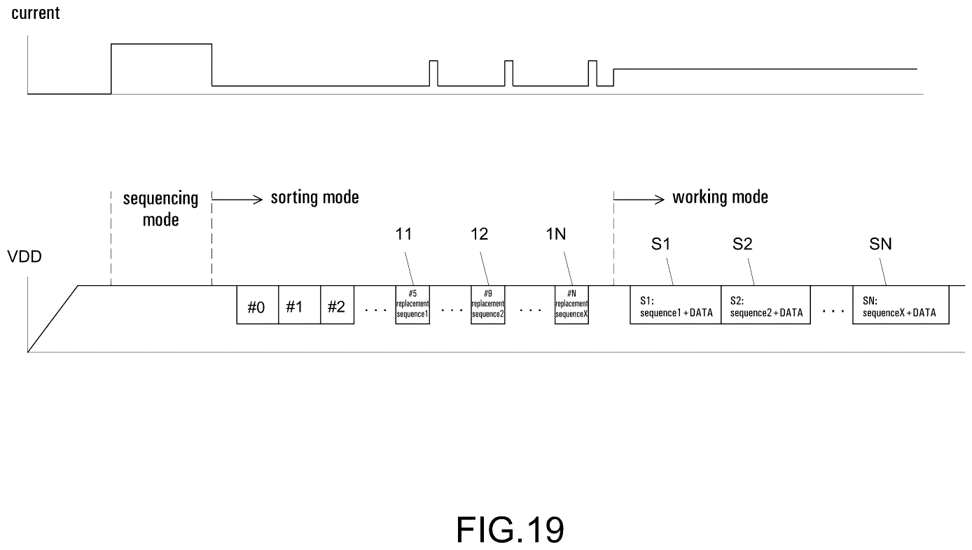

The second method, and refer to FIG. 19. The second method is similar to the first method, which also uses the number of lighting behaviors to perform replacement. The difference is that after a specific LED lamp is sorted, the comparator 121 controls the sorting code register 170 to store the replacement signal received next. The control device 100 then sends a replacement signal with the sequence sorting code (sequence 1 to X), wherein the replacement signal only has a sequence sorting code (sequence 1 to X) of 8-bit data size. Specifically, when the first LED lamp 11 is sorted (sorting code is #5), the control device 100 will first send a replacement signal such as a sequence sorting code (sequence 1) of 8-bit data size. The comparator 121 of the first LED lamp 11 controls the sorting code register 170 to store the sequence 1 of 8-bit data size after receiving the replacement signal, thereby completing the replacement of the original sorting code #1 to #N of 20-bit data size. Afterward, the control device 100 continues to send the next original sorting codes as #6, #7, . . . , etc., so that the other LED lamps 12, 13, . . . , 1N can be sorted. After the LED lamps 11, 12, 13, . . . , 1N are sorted, the replacement method described above is performed.

The third method, and refer to FIG. 19. The third method differs from the first method and the second method in that it mainly uses the number of disturbance signals to perform replacement. Specifically, when the LED light string 10 includes the mechanism for double-confirmation, and the LED lamps 11, 12, 13, . . . , 1N have completed sorting, its comparator 121 controls the sorting code register 170 to generate and store a replacement signal. In particular, the replacement signal is a sequence sorting code (sequence 1 to X) of 8-bit data size. Furthermore, when the first LED lamp 11 completes the sorting (sorting code is #5), in addition to generating lighting behavior, it also generates a disturbance signal is generated. The comparator 121 sends a control command to control the sorting code register 170 to detect and record the number of disturbance signals on the LED light string 10, and the number of times this record is the replacement signal. Since the first LED lamp 11 is the first one to generate the disturbance signal, the sorting code register 170 of the first LED lamp 11 generates a replacement signal of the sequence sorting code (sequence 1) of 8-bit data size according to the number of disturbance signals detected, such as 1, thereby replacing the original sorting code #5. Similarly, after the second LED lamp 12 is sorted, its sorting code register 170 generates a replacement signal of the sequence sorting code (sequence 2) of 8-bit data size according to the number of disturbance signals detected, such as 2, and stores it to replace the original sorting code #9.

The first and second substitution methods may also be implemented using disturbance signals and is not repeated description thereto. In addition, although the above three replacement methods are all based on the fifth embodiment of the two-wire structured LED apparatus 20 as an example, they may also be applied to other two-wire structured LED apparatuses 20 disclosed in the present disclosure and other three-wire structured LED apparatuses 20 disclosed in the present disclosure, and is not repeated description thereto.

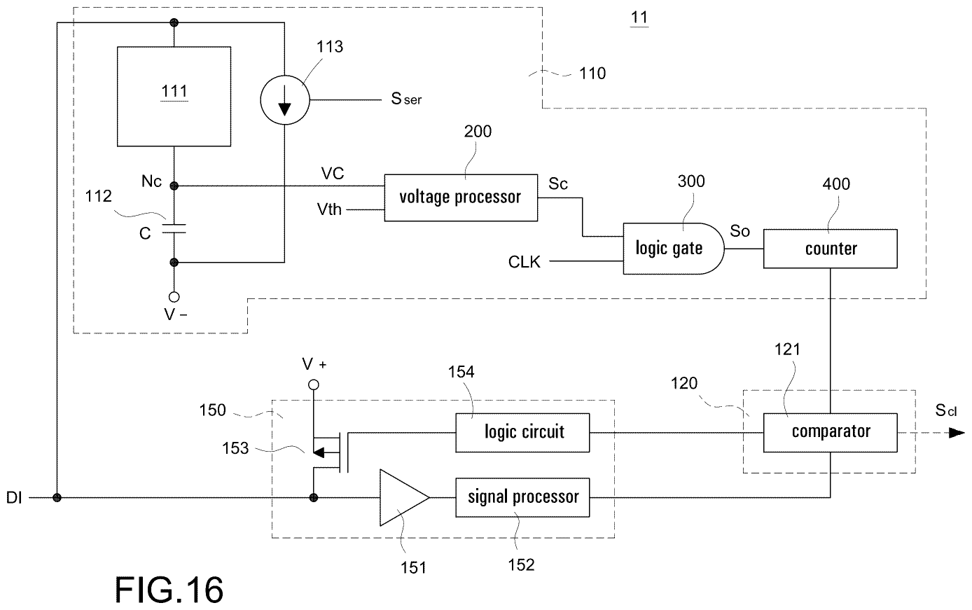

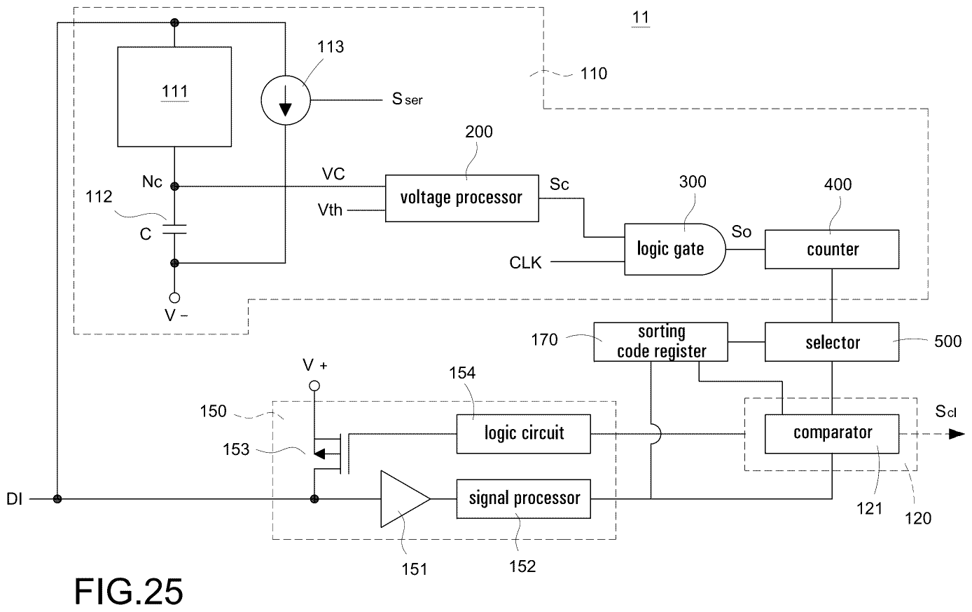

Please refer to FIG. 25, which shows a block circuit diagram of the LED apparatus having the third-wire structure according to a fifth embodiment of the present disclosure, and its structure is similar to that of FIG. 16 (detailed features of FIG. 16 further described below). The difference is that the LED apparatus 20 is further provided with a selector 500 and a sorting code register 170 to perform the above-mentioned replacement methods. The selector 500 is electrically connected to the counter 400, the sorting code register 170, and the comparator 121. The sorting code register 170 is electrically connected to a signal processor 152. However, if the third method of the above-mentioned replacement methods is performed, the electrical connection relationship may also be omitted. When the first method of the above-mentioned replacement method is performed, taking the first LED lamp 11 as an example, the LED apparatus 20 of the first LED lamp 11 and the sorting code register 170 receive the original sorting code #5 and the replacement signal with original sorting code and the sequence sorting code (sequence 1) through the signal processor 152. Afterward, the comparator 121 compares the serial number of the counter 400 provided by the selector 500 and confirms that they are the same, the comparator 121 sends a control command to control the sorting code register 170 to store a new sequence sorting code of 8-bit data size (the sequence 1 corresponds to the serial number stored in the LED apparatus 20 of each of the LED lamps 11, 12, 13, . . . , 1N), thereby replacing the original sorting code #5 of 20-bit data size. The performances of the second method and the third method are the same as those of the above-mentioned two-wire structure, and thus will not be repeated.

Please refer to FIG. 22, which shows a schematic diagram of a packaging structure of an LED lamp according to a first embodiment of the present disclosure. The LED lamp includes two power pins Vd, Vs, at least one LED 21, one LED apparatus 20, and a package 30. The two power pins Vd, Vs receive a voltage. The at least one LED 21 is coupled to the two power pins Vd, Vs. The detailed description of the LED apparatus 20 may be found in the above contents, which will not be further described here. The package 30 is used to package the LED apparatus 20, the at least one LED 21, and a part of the two power pins Vd, Vs, and the other part of the two power pins Vd, Vs is exposed outside the package 30.

Please refer to FIG. 11, which shows a block circuit diagram of the LED light string having a three-wire structure according to a first embodiment of the present disclosure. Different from the above-mentioned two-wire structure, the so-called three-wire structure refers to the control and operation of the LED light string 10 being realized by two power wires and one data wire. Therefore, the control device 100 provides a data wire DI, and the data wire DI is connected to the LED apparatuses 20 of the LED lamp 11, 12, 13, . . . , 1N respectively. Furthermore, the embodiment shown in FIG. 11 may optionally include a resistor R, and therefore the control device 100 is triggered to record the sorting codes #1 to #N as the serial position of the LED lamp 11 in the LED light string 10 according to the current disturbance signal generated on the resistor R (which can be acquired by detecting a voltage across two terminals of the resistor R by the control device 100) to provide the mechanism for double-confirmation.

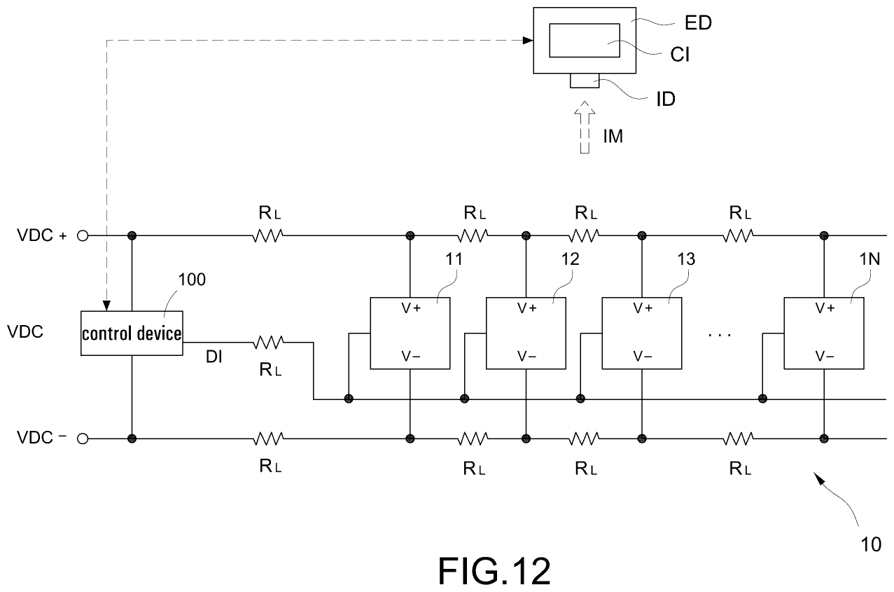

Please refer to FIG. 12, which shows a block circuit diagram of the LED light string having the three-wire structure according to a second embodiment of the present disclosure. Compared with FIG. 11, the embodiment shown in FIG. 12 may not include the resistor R. The control device 100 may directly acquires the voltage disturbance signal through the wire resistance RL of the data wire DI itself, and is triggered to record the sorting codes #1 to #N as the serial position of the first LED lamp 11 in the LED light string 10 to provide the mechanism for double-confirmation.

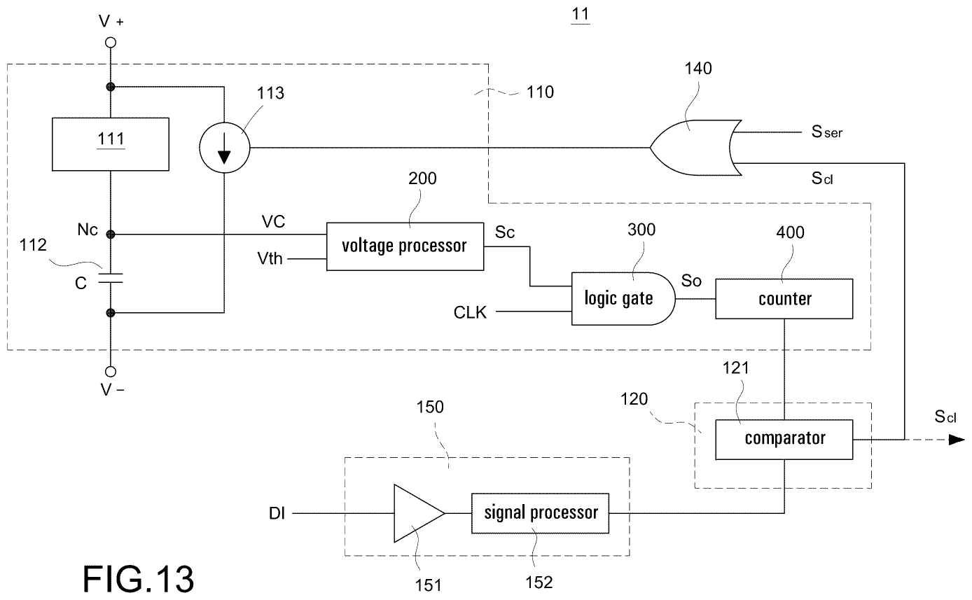

Please refer to FIG. 13, which shows a block circuit diagram of the LED apparatus having a three-wire structure according to a first embodiment of the present disclosure. The embodiment of FIG. 13, in conjunction with the three-wire structure of FIG. 11, can implement operations of sequencing through the power wires and sorting through the data wire DI. The operation mechanism of the sequencing and sorting is substantially the same as that of the implementation of FIG. 9, and will not be described in detail. The difference of FIG. 13 and FIG. 9 is that, since FIG. 13 uses the data wire DI sorting, the LED apparatus 20 further includes a signal processing unit 150. The signal processing unit 150 is connected to the data wire DI, and includes a signal amplifier 151 and a signal processor 152. In particular, the control device 100 sends the sorting codes #1 to #N to all the LED 11, 12, 13, . . . , 1N of the LED apparatus 20 through the data wire DI. Furthermore, in order to prevent the signal strength of the data wire DI from being too low, the signal amplifier 151 and the signal processor 152 are used for signal amplification and filtering so that signals of the sorting codes #1 to #N can be completely sent to the comparator 121.

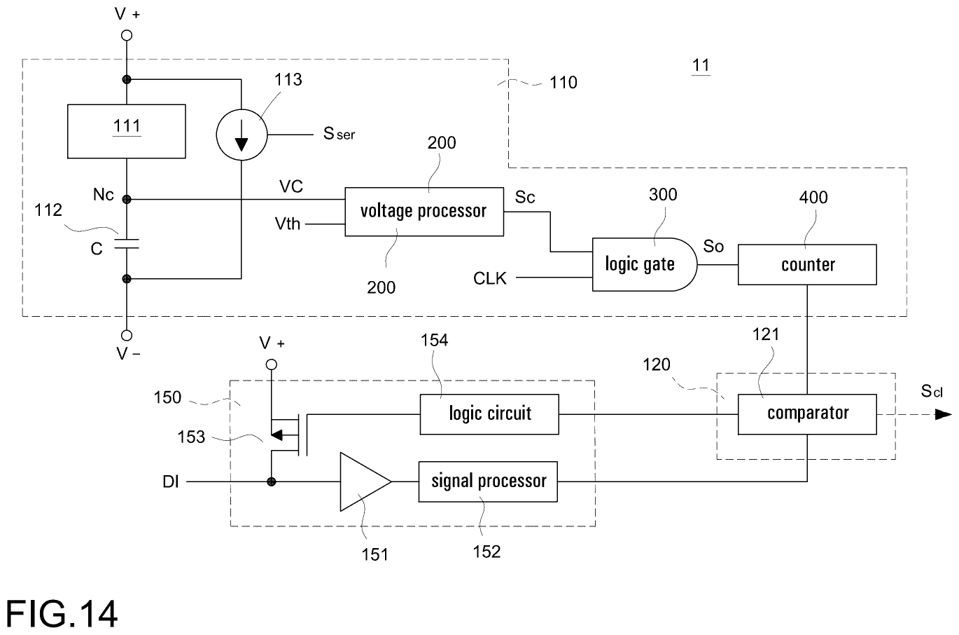

Please refer to FIG. 14, which shows a block circuit diagram of the LED apparatus having the three-wire structure according to a second embodiment of the present disclosure. The LED apparatus 20 further includes a signal processing unit 150 connected to the data wire DI, and the signal processing unit 150 includes a signal amplifier 151, a signal processor 152, a switch 153, and a logic circuit 154. The switch 153 is connected to a voltage source (not shown), and the current load 113 directly receives a sequencing signal Sser. The embodiment of FIG. 14, in conjunction with the three-wire structure of FIG. 12, can implement operations of sequencing through the power wires and sorting through the data wire DI. The implementation of the specific sequencing operation is roughly the same as above and will not be repeated here. The difference between FIG. 14 and FIG. 12 is that, in the circuit structure of FIG. 14, during sequencing, the control device 100 sends a sequencing signal Sser to activate the current load 113 to provide current for sequencing. When the comparator 121 determines that the comparison result between the serial number and one of the sorting codes #1 to #N is the same, the comparator 121 sends a signal to control the logic circuit 154 to turn on the switch 153 for a period of time. During the conduction (turned-on) period of the switch 153, since the switch 153 is electrically connected to the voltage source, a voltage is applied to the data wire DI after the switch 153 is turned on to generate a current disturbance signal to the LED light string 10. Therefore, the control device 100 may records this sorting code #1 to #N as the serial position of the first LED lamp 11 in the LED light string 10 according to the voltage change fed back on the data wire DI to provide a double-confirmation mechanism.

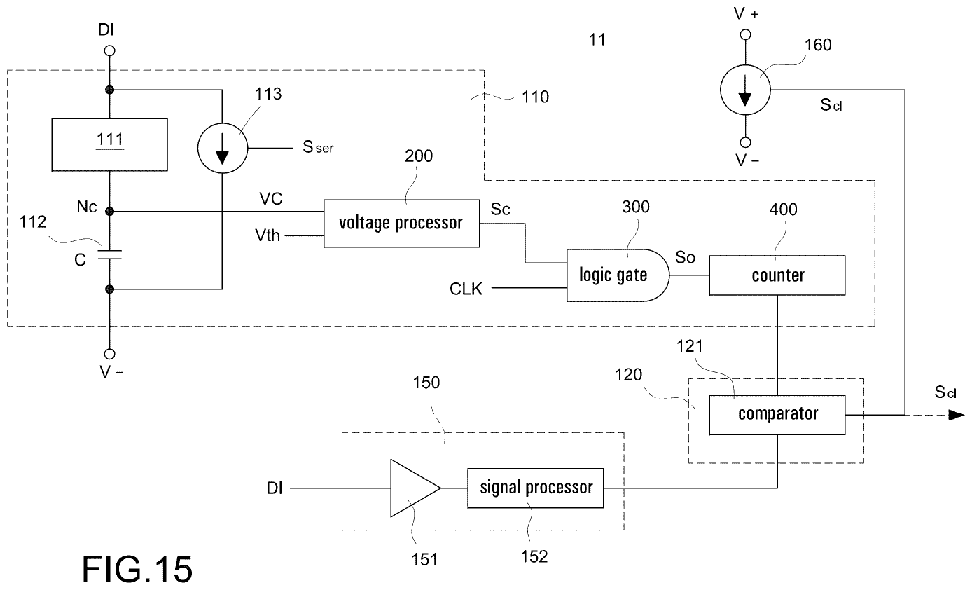

Please refer to FIG. 15, which shows a block circuit diagram of the LED apparatus having the three-wire structure according to a third embodiment of the present disclosure. The LED apparatus 20 further includes a signal processing unit 150 and a current source 160. The signal processing unit 150 is connected to the data wire DI, and includes a signal amplifier 151 and a signal processor 152, having the same functions as those in the embodiment of FIG. 13. The current source 160 receives the control signal Scl and is controlled by the control signal Scl. The embodiment of FIG. 15, in conjunction with the three-wire structure of FIG. 11, can implement operations of sequencing through the data wire DI and sorting through the power wires. The difference from the previous embodiments is that when the sequencing is completed, the counter 400 provides a sequencing signal Sser to the current load 113 to disable it. When the comparator 121 determines that the comparison result between the serial number and one of the sorting codes #1 to #N is the same, the comparator 121 sends the control signal Scl to cause the LED apparatus 20 to control its own first LED lamp 11 to generate the lighting behavior, and the control signal Scl also controls the current source 160 to activate a current to the LED light string 10 for a period of time. Therefore, the control device 100 can detect the change of the current through the voltage change fed back from the power wires and record this sorting code #1 to #N as the serial position of the first LED lamp 11 in the LED light string 10 to provide a double-confirmation mechanism.

Please refer to FIG. 16, which shows a block circuit diagram of the LED apparatus having the three-wire structure according to a fourth embodiment of the present disclosure. The LED apparatus 20 further includes a signal processing unit 150 connected to the data wire DI, and the signal processing unit 150 includes a signal amplifier 151, a signal processor 152, a switch 153, and a logic circuit 154. The embodiment of FIG. 16, in conjunction with the three-wire structure of FIG. 12, can implement operations of sequencing through the data wire DI and sorting through the data wire DI. The implementation is substantially the same as the previous implementation of FIG. 14, the only difference is that the data wire DI is provided to control the operation of the sequencing circuit 110, and the rest is similar to FIG. 14 and is not repeated description thereto.

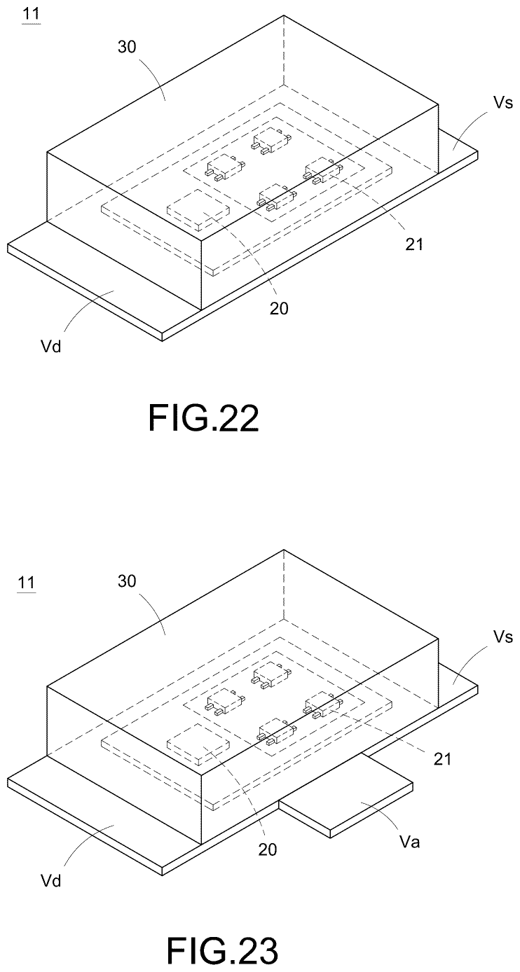

Please refer to FIG. 23, which shows a schematic diagram of a packaging structure of the LED lamp according to a second embodiment of the present disclosure. The specific structure of the first LED lamp 11 is roughly the same as that of the above-mentioned FIG. 22, which will not be further described here. The difference is that the first LED lamp 11 further includes a data pin Va. By connecting the data pin Va to the data wire DI, the three-wire LED light string 10 shown in FIG. 11 to FIG. 16 may be applied, and the package 30 is used to package the LED apparatus 20, the at least one LED 21, a part of the two power pins Vd, Vs, and a part of the data pin Va, and the other part of the two power pins Vd, Vs and the other part of the data pin Va are exposed outside the package 30.

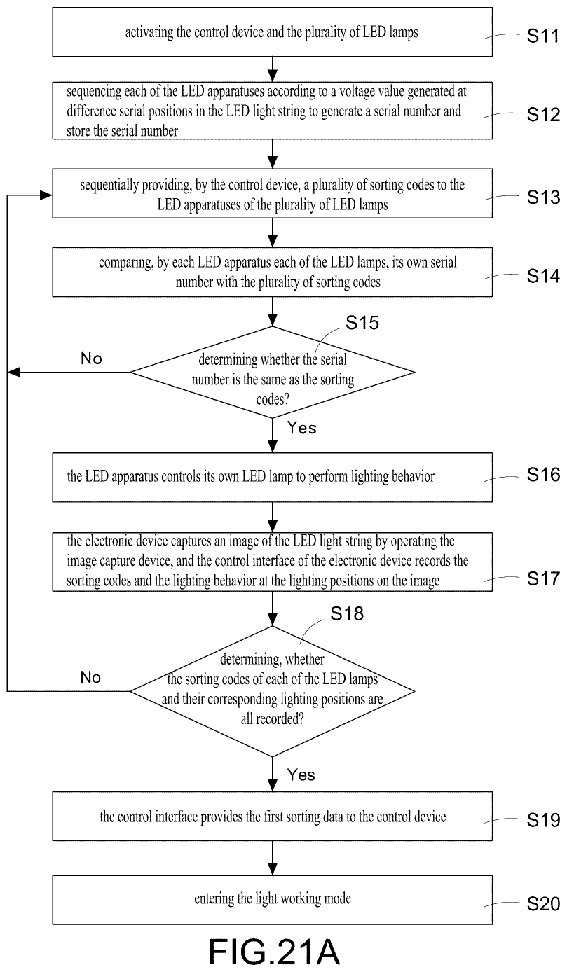

Please refer to FIG. 21A, which shows a flowchart of a method of operating the LED light string according to the present disclosure. The LED light string 10 includes a control device 100 and a plurality of LED lamps 11, 12, 13, . . . , 1N connected with the control device 100. Each LED lamp 11, 12, 13, . . . , 1N includes an LED apparatus 20. For other circuits and devices included in the LED light string 10 and the LED apparatus 20, please refer to the above-mentioned contents and will not be described in detail here.

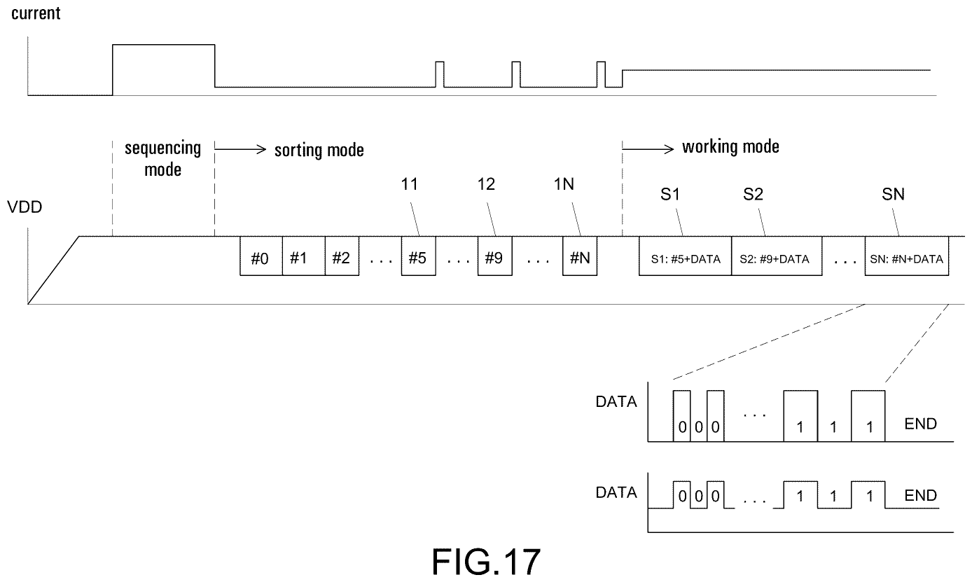

The method includes the following steps of: first, receiving a DC power source VDC by the LED light string to activate the control device 100 and the plurality of LED lamps 11, 12, 13, . . . , 1N, where each LED lamp 11, 12, 13, . . . , 1N includes an LED apparatus 20 (step S11). Afterward, sequencing each of the LED apparatuses 20 according to a voltage value generated at difference serial positions in the LED light string 10 to generate a serial number and store the serial number (step S12), in particular, the serial numbers are not necessarily a continuous series. Please refer to FIG. 17, which shows a schematic diagram of operating the LED light string according to a first embodiment of the present disclosure, the voltage VDD and current waveform of the LED light string 10 are mainly shown. The first LED lamp 11 has a serial number #5, the second LED lamp 12 has a serial number #9, and the serial numbers of the other LED lamps will be gradually larger values.

Afterward, sequentially providing, by the control device 100, a plurality of sorting codes #1 to #N to the LED apparatuses 20 of the plurality of LED lamps 11, 12, 13, . . . , 1N (step S13), and comparing, by each LED apparatus 20 each of the LED lamps 11, 12, 13, . . . , 1N, its own serial number with the plurality of sorting codes #1 to #N (step S14), that is, determining whether the serial number is the same as the sorting codes #1 to #N (step S15). If the determination result of step S15 is “No”, return to step S14 to compare the own serial number with the sorting codes #1 to #N again. On the contrary, if the determination result of step S15 is “Yes”, the LED apparatus 20 controls its own first LED lamp 11 to perform lighting behavior (step S16). At this time, the electronic device ED captures an image IM of the LED light string 10 by operating the image capture device ID, and the control interface CI of the electronic device ED records the sorting codes #1 to #N and the lighting behavior generated in step S16 at the lighting positions on the image IM (step S17).

Then, determining, whether the sorting codes #1 to #N of each of the LED lamps 11, 12, 13, . . . , 1N and their corresponding lighting positions are all recorded (step S18). If the comparison result of step S18 is “no”, return to step S13 to provide multiple sorting codes #1 to #N to the LED apparatus 20 of each of the LED lamps 11, 12, 13, . . . , 1N again for comparison. On the contrary, if the comparison result of step S18 is “yes”, it means that the serial numbers and lighting positions of the LED apparatus 20 of each of the LED lamps 11, 12, 13, . . . , 1N are recorded with the corresponding sorting codes #1 to #N. Therefore, the control interface CI provides the first sorting data Sd1 to the control device 100 (step S19), so that the control device 100 acquires the lighting positions of the LED lamps 11, 12, 13, . . . , 1N in the LED light string 10 through the first sorting data Sd1, and the lighting positions correspond to the serial positions of the LED lamps 11, 12, 13, . . . , 1N in the LED light string 10.

Finally, it enters the light working mode (step S20). In the light working mode, the control device 100 sends a lighting signal to the LED apparatus 20 of each of the LED lamps 11, 12, 13, . . . , 1N according to the recorded sorting codes #1 to #N and the light working mode, so as to control the LED lamps 11, 12, 13, . . . , 1N to perform a specific lighting behavior.

In step S20, the LED apparatus 20 of each of the LED lamps 11, 12, 13, . . . , 1N receives the lighting signal. In particular, the lighting signal may include a single sorting code #1 to #N and light information corresponding to the sorting code #1 to #N, which are provided independently to the specified LED lamp of the LED lamps 11, 12, 13, . . . , 1N. Alternatively, the lighting signal may include light information containing the sequence of sorting codes #1 to #N, so that each of the LED lamps 11, 12, 13, . . . , 1N may extract the information segment required by itself. When the sorting codes #1 to #N matches the serial number stored in its own counter 400, the LED lamps 11, 12, 13, . . . , 1N execute the specific lighting behavior of the light information. Specifically, the specific lighting behavior is the lighting effect produced by the LED apparatus 20 according to the lighting signal to control the LED 21, such as continuous lighting, color change, fast flashing, slow flashing, running lights, etc.

Referring to FIG. 21B, which show a flowchart of a method of additional operating the LED light string having a sequencing function according to the present disclosure, and the LED light string 10 include additional steps under a double-confirmation mechanism. Specifically, when the determination result of step S15 is “yes”, the LED apparatus 20 generates a disturbance signal to the LED light string 10 (see the current waveform in FIG. 17). For example, when the first LED lamp 11 having the sorting code #5 and its serial number is the same as the sorting code #5, or when the second LED lamp 12 having the sorting code #9 and its serial number is the same as the sorting code #9, and the control device 100 to record the sorting code #5 as the serial position of the first LED lamp 11 in the LED light string 10 (step S31). In particular, the disturbance signal may be implemented by a voltage disturbance signal or a current disturbance signal, and the specific implementation has been described above and will not be repeated here.

Then, determining, whether the sorting codes #1 to #N and their corresponding serial positions of each of the LED lamps 11, 12, 13, . . . , 1N have been recorded (Step S32). If the determination result of step S32 is “No”, returning to step S13 to provide the plurality of the sorting codes #1 to #N to the LED apparatus 20 of each of the LED lamps 11, 12, 13, . . . , 1N again for re-comparison. Conversely, if the determination result of step S32 is “yes”, the serial numbers of the LED apparatus 20 of each of the LED lamps 11, 12, 13, . . . , 1N are recorded with the corresponding sorting codes #1 to #N. Therefore, the control device 100 generates the second sorting data Sd2 (step S33). When the LED light string 10 includes the additional operation of FIG. 21B, a determination step S34 is added to steps S19 and S33 to double-confirm whether the first sorting data Sd1 corresponds to the second sorting data Sd2. Furthermore, if the determination result of step S34 is “No”, returning to step S13 to provide the plurality of sorting codes #1 to #N to the LED apparatus 20 of each of the LED lamps 11, 12, 13, . . . , 1N again for re-comparison. Conversely, if the determination result of step S34 is “yes”, then enter step S20.

In addition, please refer to FIG. 18, FIG. 19, FIG. 21A and FIG. 21B simultaneously. In another embodiment, in step S18, the control device 100 may further include counting the number of times the LED light string 10 generates lighting behaviors (total number=number of LED lamps). Correspondingly, the control device 100 records and replaces (overwrite) the sorting code according to the number of lighting behaviors. For example, as shown in FIG. 18, after all the sorting modes are completed, the replacement (overwriting) is performed uniformly, or as shown in FIG. 19, the replacement (overwriting) may be performed one by one while each LED apparatus 20 generates the lighting behavior. The specific replacement (overwriting) implementation has been described above and will not be repeated here.

For another embodiment, in step S18, further including: the control device provides the sorting codes in the form of a continuous (or discontinuous) increasing sequence until the control interface has recorded at least two lighting behaviors, and calculates an incremental value such as 4 according to a difference value between the sorting codes of the LED lamps 11, 12 corresponding to the at least two lighting behaviors. Then, generating a sorting code starting value such as #13 according to the incremental value, and continue providing an increasing sorting code (similarly for the decreasing sorting code).

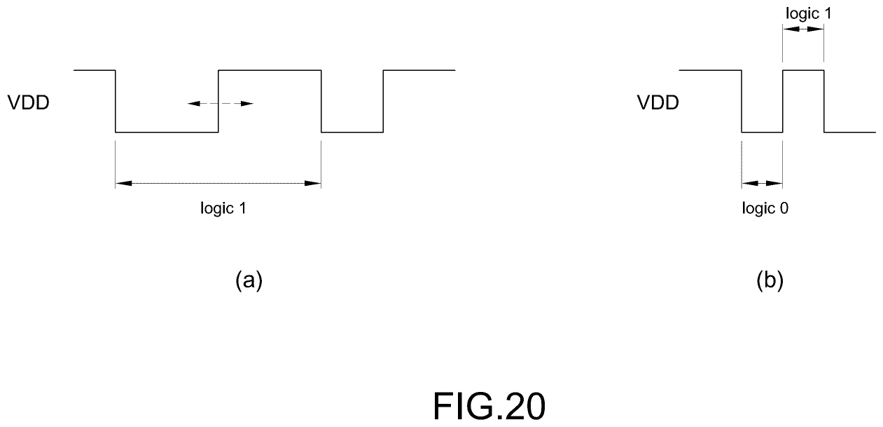

Please refer to FIG. 20, which shows a schematic waveform diagram of a data format of a lighting signal according to the present disclosure. The replacement signals (sequence 1 to X), the sorting codes #1 to #N and the lighting signals provided by the control device 100 are digital signals composed of a plurality of pulses having a plurality of pulse widths. The replacement signals (sequence 1 to X) and the sorting codes #1 to #N may also be single pulses with fixed or variable pulse widths, and the LED apparatus 20 is used to perform the sorting work referred to in the present disclosure by receiving and counting. The control device 100 and the LED apparatus 20 respectively use the pulse width of each pulse with single high level or single low level as a judgment reference of a digital signal. For example, as shown in small picture (a) of FIG. 20, the original 1-bit (i.e., the pulse width with a single high level plus or a single low level) is used as the judgment reference of the digital signal (e.g., 0 or 1). The logical judgment of “0” or “1” is mainly according to the size of the duty cycle of a single high level or a single low level in 1-bit. For example, but not limited to, in 1-bit, a single high level with a duty cycle of 50% represents “1” (as shown in FIG. 20), and in 1-bit, a single high level with a duty cycle of 25% represents “0” (not shown). However, as shown in small picture (b) of FIG. 20, the present disclosure requires only the pulse width with of the single high level or the single low level as the judgment reference of the digital signal. In other words, the pulse signal width at the single high level may be expressed as a logic “1”, and the pulse signal width at the single low level may be expressed as a logic “0”. So that, more LED apparatuses can be transmitted by shortening the bit length, or with the same number of lights, the amount of data can be greatly reduced.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of operating an LED light string, the LED light string comprising a control device for transmitting signal to an electronic device and a plurality of LED lamps electrically connected to the control device, each LED lamp comprising an LED apparatus, the method of operating the LED light string comprising steps of:
(a) receiving, by the LED light string, a DC power source to activate the control device and each LED apparatus,
(b) sequencing each LED apparatus according to the DC power source received at its own different serial positions in the LED light string to generate a serial number and store the serial number,
(c) providing, by the control device, a plurality of sorting codes to LED apparatuses, and comparing, by each LED apparatus, its own serial number with each of the sorting codes,
(d) controlling, by each LED apparatus, its own LED lamps to generate a lighting behavior when one of the LED apparatuses compares the stored serial number with one of the sorting codes and a comparison result is the same.

2. The method of operating the LED light string as claimed in claim 1, further comprising steps of:
(e) capturing an image of the LED light string by operating an image capture device by the electronic device, and recording, by a control interface of the electronic device, one of the sorting codes and the lighting behavior at a lighting position on the image, and
(f) repeatedly performing, by the control interface, step (c) to step (e), to acquire the lighting position and a sorting code of each of the LED lamps.

3. The method of operating the LED light string as claimed in claim 2, wherein in step (f) further comprising a step of:
(f′) providing, by the control interface, a first sorting data, and acquiring, by the control device, the serial positions of each of the LED lamps in the LED light string according to the first sorting data, until the sorting code of each of the LED lamps and the lighting position of each of the LED lamps are recorded.

4. The method of operating the LED light string as claimed in claim 2, wherein in step (c) further comprising steps of:
(c11) receiving, by the control interface, a sorting command to the control device through a signal transmission, and
(c12) converting, by the control device, the sorting command into the sorting codes to provide the sorting codes to the LED apparatuses.

5. The method of operating the LED light string as claimed in claim 2, wherein in step (c) further comprising steps of:
(c21) transmitting, by the control device, the sorting codes to the control interface through the signal transmission so as to record the sorting codes and the lighting behavior of each of the LED lamps at the lighting position on the image by a control interface, and
(c22) providing, by the control device, the sorting codes to the LED apparatuses.

6. The method of operating the LED light string as claimed in claim 2, wherein in step (f) further comprising steps of:
counting, by the control interface, a number of times the LED light string generates the lighting behavior through the image; and
providing, by the control device, a plurality of sequence sorting codes to replace the sorting codes according to the number of times.

7. The method of operating the LED light string as claimed in claim 3, further comprising steps of:
(g) generating, by the LED apparatus, a disturbance signal for the LED light string and recording, by the control device, the sorting code as the serial positions of an LED lamp in the LED light string when the LED apparatus compares the stored serial number with the sorting code and the comparison result is the same, and
(f) repeatedly performing, by the control device, step (c) and step (g), to generate a second sorting data, and comparing the first sorting data with the second sorting data to double-check the serial positions, until the sorting code of each of the LED lamps is recorded.

8. The method of operating the LED light string as claimed in claim 7, wherein in step (h) further comprising steps of:
detecting, by the LED apparatus, a number of times the disturbance signal, and
generating, by the LED apparatus, a sequence sorting code to replace the sorting code according to the number of times.

9. The method of operating the LED light string as claimed in claim 2, wherein after step (f) further comprising steps of:
(f1) receiving, by the LED apparatus, a lighting signal and the lighting signal includes the sorting code and a lighting information corresponding to the sorting code, or the lighting signal includes the lighting information with the sorting code in sequence; and
(f2) performing, by the LED apparatus, a particular lighting behavior of the lighting information when the serial number of its own LED apparatus corresponds to the sorting code or a sequence of the sorting codes of the lighting signal.

10. The method of operating the LED light string as claimed in claim 2, wherein in step (f) further comprising steps of:
providing, by the control device, the sorting codes in the form of an increasing sequence until the control interface has recorded at least two lighting behaviors,
calculating an incremental value according to a difference value between the sorting codes of the LED lamps corresponding to the at least two lighting behaviors, and
generating a sorting code starting value according to the incremental value and providing the sorting codes in further increments from the sorting code starting value.

11. The method of operating the LED light string as claimed in claim 2, wherein in step (f) further comprising steps of:
providing, by the control device, the sorting codes in the form of a decreasing sequence until the control interface has recorded at least two lighting behaviors,
calculating a decremental value according to a difference value between the sorting codes of the LED lamps corresponding to the at least two lighting behaviors, and
generating a sorting code starting value according to the decremental value and providing the sorting codes in further decrements from the sorting code starting value.

12. An LED light string system comprising an LED light string receiving a DC power source, the LED light string comprising:
a control device; and
a plurality of LED lamps, each LED lamp comprising an LED apparatus, and each LED apparatus comprising:
a sequencing circuit configured to sequence each LED apparatus according to the DC power source received at its own different serial position in the LED light string to generate a serial number and store the serial number,
wherein each LED apparatus is configured to control its own LED lamps to generate a lighting behavior when one of the LED apparatuses compares the stored serial number with one of a plurality of sorting codes and a comparison result is the same.

13. The LED light string system as claimed in claim 12, wherein the control device is configured to receive a first sorting data comprising a sorting code of each of the LED lamps and a lighting position of each of the LED lamps to acquire the serial position of each of the LED lamps in the LED light string according to the first sorting data.

14. The LED light string system as claimed in claim 13, wherein each of the LED apparatuses further comprises:
a sorting circuit configured to receive the sorting codes, and the sorting circuit of each of the LED apparatuses configured to compare its own serial number with the sorting codes.

15. The LED light string system as claimed in claim 14, further comprising:
an image capture device configured to capture an image of the LED light string,
a control interface configured to record one of the sorting codes with a lighting behavior of each of the LED lamps at a lighting position on the image, and configured to perform a signal transmission with the control device,
wherein the control interface is configured to transmit the first sorting data to the control device by the signal transmission when the sorting code of each of the LED lamps and a lighting position of each of the LED lamps are recorded.

16. The LED light string system as claimed in claim 15, wherein the control device comprises:
a signal conversion unit configured to convert a sorting command transmitted by the control interface into the sorting codes.

17. The LED light string as claimed in claim 15, wherein the control device is configured to transmit the sorting codes to the control interface by the signal transmission.

18. The LED light string system as claimed in claim 15, wherein the control interface comprises:
a counting unit configured to count a number of times the LED light string generates the lighting behavior by the image,
wherein the control device is configured to provide a plurality of sequence sorting codes to replace the sorting codes according to the number of times.

19. The LED light string system as claimed in claim 14, wherein when the sorting circuit compares the stored serial number with the sorting code and the comparison result is the same, the LED apparatus is configured to generate a disturbance signal for the LED light string, and the control device is configured to record the sorting code as the serial positions of an LED lamp in the LED light string according to the disturbance signal; until the sorting code of each of the LED lamps is recorded, the control device is configured to generate a second sorting data and compare the first sorting data with the second sorting data to double-confirmation the serial positions.

20. The LED light string system as claimed in claim 19, wherein the sorting circuit comprises:
a comparator compare configured to compare the sorting codes with the serial number provided by the sequencing circuit, so that the LED apparatus determines whether to generate the disturbance signal for the LED light string according to the comparison result, and controls its own LED lamp to generate the lighting behavior.

21. The LED light string system as claimed in claim 19, wherein the LED apparatus is configured to detect a number of times the disturbance signal, and is configured to generate a sequence sorting code to replace the sorting code according to the number of times.

22. The LED light string system as claimed in claim 14, wherein the sorting circuit comprises:
a comparator compare configured to compare the sorting codes with the serial number provided by the sequencing circuit, so that the LED apparatus determines whether or not to control its own LED lamp to generate the lighting behavior according to the comparison result.
